(19) United States
(12) Patent Application Publication
(10) Pub. No.: US 2024/0306239 A1
(43) Pub. Date: Sep. 12, 2024

(54) METHOD AND SYSTEM FOR SECONDARY NODE RECOVERY IN NON-STANDALONE COMMUNICATION SYSTEM

(71) Applicant: SAMSUNG ELECTRONICS CO., LTD., Suwon-si (KR)

(72) Inventors: Abhishek CHATURVEDI, Bangalore (IN); Manasi EKKUNDI, Bangalore (IN); Neha SHARMA, Bangalore (IN); Dongmyoung KIM, Suwon-si (KR)

(21) Appl. No.: 18/425,349

(22) Filed: Jan. 29, 2024

Related U.S. Application Data
(63) Continuation of application No. PCT/KR24/00877, filed on Jan. 17, 2024.

(30) Foreign Application Priority Data
Mar. 10, 2023 (IN) 202341016233
Dec. 18, 2023 (IN) 202341016233

(51) Int. Cl. H04W 76/19; H04B 17/318; H04W 28/26; H04W 76/20

(52) U.S. Cl. CPC H04W 76/19; H04B 17/328; H04W 28/26; H04W 76/20

(57) ABSTRACT

The present disclosure relates to a method performed by a user equipment (UE) for secondary node failure recovery in a non-standalone (NSA) communication system. The method comprises identifying failure in a secondary node, the UE being connected to a master node and the secondary node. The method comprises sending, to the master node, information related to the failure of the secondary node and an indication of a presence of a fallback secondary node configuration. The method comprises evaluating, an execution condition of the fallback secondary node based on a plurality of connection parameters. The method comprises sending to the master node, a Radio Resource Control (RRC) reconfiguration complete message to connect to the fallback secondary node based on that the evaluation condition is succeeded.

### CROSS-REFERENCE TO RELATED APPLICATIONS

This application is a continuation of International Application No. PCT/KR2024/000877, designating the United States, filed on Jan. 17, 2024, in the Korean Intellectual Property Receiving Office and claiming priority to Indian Provisional Patent Application No. 202341016233, filed on Mar. 10, 2023, and to Indian Complete Patent Application No. 202341016233, filed on Dec. 18, 2023, in the Indian Patent Office, the disclosures of each of which are incorporated by reference herein in their entireties.

### BACKGROUND

### Field

The disclosure relates to a telecommunication network, for example, the disclosure relates to a method and system for secondary node recovery in Non-Standalone (NSA) communication system.

### Description of Related Art

3GPP has taken measures to provide seamless services with evolving communication technologies. Provisions are made to use core resources of one technology and radio resources from another technology. Standalone Architecture includes using a core and radio resources of a same technology (for example using 6G core and 6G RAN). Non-Standalone Architecture (NSA) includes using core of one technology and RAN of different technology (for example, using 5G core and 6G RAN and using 4G core and 5G/6G RAN). A problem associated with the usage of higher frequency ranges (example 6G) is that, they are prone to multiple disadvantages, due to their inherent characteristics, such as being affected by diffraction and material penetration, being affected by reflection and scattering, high attenuation, oxygen absorption, requiring larger bandwidths, large antenna arrays, beamforming and spatial consistency, propagation loss, absorption loss, small and large scale fading etc.

Stringent latency requirements specified in higher frequencies such as 6G wireless technology specifications ranges from 10-100 microseconds to include and cater to requirements such as real-time health monitoring, safety, remote connectivity, industrial automation (also including Artificial Intelligence(AI)/Machine Learning(ML) processing) support. A User Equipment(UE), while operating in the 6G spectrum (with deployment in NSA dual connectivity mode with LTE or NR (4G or 5G) as the core network), may face significant cellular link failure followed by post failure recovery mechanism(s) and the ‘signaling’ and ‘synchronization’ delays associated with them. This will cause degradation in terms of user experience (link failure with drop in bandwidth) and latency requirements. It would negatively impact real time use cases. To meet stringent key performance indicators (KPIs) and/or key performance values (KVIs), it is necessary to define the required changes in the existing Secondary Cell Group (SCG)/Secondary Node (6G) failure handling procedures and methods to achieve faster SCG(6G) link recovery to improve user-experience and to reduce latency.

The information disclosed in this background of the disclosure section is merely for enhancement of understanding of general background and should not be taken as an acknowledgement or any form of suggestion that this information forms the prior art already known to a person skilled in the art.

### SUMMARY

In an example embodiment, the present disclosure provides a method performed by a user equipment (UE) for secondary node failure recovery in a non-standalone (NSA) communication system. The method comprises identifying failure in a secondary node, the UE being connected to a master node and the secondary node. The method comprises sending, to the master node, information related to the failure of the secondary node and an indication of a presence of a fallback secondary node configuration. The method comprises evaluating an execution condition of the fallback secondary node based on a plurality of connection parameters. The method comprises sending to the master node, Radio Resource Control (RRC) reconfiguration complete message to connect to the fallback secondary node based on that the evaluation condition is succeeded.

In an example embodiment, the present disclosure provides a method performed by a master node for secondary node failure recovery in an NSA communication system. The method comprises sending a secondary node an addition request to a plurality of secondary nodes. The method comprises receiving configuration parameters of the plurality of secondary nodes. The method comprises identifying a fallback secondary node for the UE from the plurality of secondary nodes. The method comprises sending to the UE, a fallback secondary node configuration for connecting the UE with the fallback secondary node in an event of a failure of a secondary node connected with the UE.

According to an example embodiment, a UE for secondary node failure recovery in a non-NSA communication system is provided. The UE comprises a memory and at least one processor, comprising processing circuitry. At least one processor, individually and/or collectively, is configured to identify failure in a secondary node, the UE being connected to a master node and the secondary node and send to the master node, information related to the failure of the secondary node and an indication of a presence of a fallback secondary node configuration. At least one processor, individually and/or collectively, is configured to evaluate an execution condition of the fallback secondary node based on a plurality of connection parameters. At least one processor, individually and/or collectively, is configured to send to the master node, RRC reconfiguration complete message to connect to the fallback secondary node based on that the evaluation condition is succeeded.

The present disclosure relates to a master node for secondary node failure recovery in a NSA communication system, the master node comprising a memory and at least one processor comprising processing circuitry. At least one processor, individually and/or collectively, is configured to send a secondary node addition request to a plurality of secondary nodes. At least one processor, individually and/or collectively is configured to receive configuration parameters of the plurality of secondary nodes. At least one processor, individually and/or collectively, is configured to identify a fallback secondary node for a UE from the plurality of secondary nodes. At least one processor, individually and/or collectively, is configured to send a fallback secondary node configuration for connecting the UE with the fallback secondary node in an event of a failure of a secondary node connected with the UE.

The foregoing summary is illustrative only and is not intended to be in any way limiting. In addition to the illustrative aspects, embodiments, and features described above, further aspects, embodiments, and features will become apparent with reference to the drawings and the following detailed description.

The accompanying drawings, which are incorporated in and are a part of this disclosure, illustrate various example embodiments and, together with the description, serve to explain the disclosed principles. Various example embodiments of system and/or methods in accordance with disclosure will be described, by way of example, and regarding the accompanying figures

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example system for secondary node recovery in non-standalone communication system, according to various embodiments;

FIG. 2 is a block diagram illustrating an example configuration of a User Equipment (UE), according to various embodiments;

FIG. 3 is a block diagram illustrating an example configuration of a master node, according to various embodiments;

FIG. 4 is a signal flow diagram illustrating example operations of secondary node addition with an LTE/NR master node in non-standalone architecture deployment and configuring of fallback secondary node, according to various embodiments;

FIG. 5 is a signal flow diagram illustrating example operations of secondary node change with an LTE/NR master node in non-standalone architecture deployment and configuring of fallback secondary node, according to various embodiments;

FIG. 6 is a flowchart illustrating an example method for fallback secondary node configuration storage, measurement, reporting and timer renewal/expiry handling, according to various embodiments;

FIG. 7 is a signal flow diagram illustrating example operations between a UE and master node in the event of failure of execution condition of fallback secondary node, according to various embodiments;

FIG. 8 is a signal flow diagram illustrating example operations in the event of failure of secondary node using valid fallback secondary node, execution condition of fallback secondary node subsequent to failure of secondary node, according to various embodiments;

FIG. 9 is a flowchart illustrating an example method for secondary node failure recovery in a non-standalone (NSA) communication system, according to various embodiments;

FIG. 10 is a flowchart illustrating an example method for secondary node failure recovery in a non-standalone (NSA) communication system, according to various embodiments; and

FIG. 11 is a block diagram illustrating an example configuration of an example computer system, according to various embodiments.

It should be appreciated by those skilled in the art that any block diagrams herein represent example conceptual views of illustrative systems embodying various principles of the present disclosure. Similarly, it will be appreciated that any flowcharts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present disclosure, the word “exemplary” is used herein to refer, for example, to “serving as an example, instance, or illustration.” Any embodiment or implementation of the present disclosure described herein as “exemplary” is not necessarily to be construed as preferred or advantageous over various embodiments.

While the disclosure is susceptible to various modifications and alternative forms, certain embodiments thereof are illustrated and described by way of example in the drawings and will be described in greater detail below. It should be understood, however that it is not intended to limit the disclosure to the particular forms disclosed, but on the contrary, the disclosure is intended to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

The terms “an embodiment”, “embodiment”, “embodiments”, “the embodiment”, “the embodiments”, “one or more embodiments”, “some embodiments”, and “one embodiment” may refer, for example, to “one or more (but not all) embodiments of the invention(s)” unless expressly specified otherwise.

The terms “including”, “comprising”, “having” and variations thereof refer, for example, to “including but not limited to”, unless expressly specified otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit may refer, for example, to the one unit being able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In various non-limiting embodiments, a message may refer to a network packet (e.g., a data packet and/or the like) that includes data. It will be appreciated that numerous other arrangements are possible.

As used herein, the term “user equipment” may refer to any electronic device that may be transported and operated by a user, which may also provide remote communication capabilities to a network and supports cellular communication. Examples of remote communication capabilities include using a mobile phone (wireless) network, wireless data network (e.g., 5G or similar networks), or any other communication medium that may provide access to a communication network. Examples of user equipment includes mobile phones (e.g., cellular phones), PDAs, tablet computers, net books, laptop computers, personal computers etc. A mobile device may comprise any suitable hardware and software for performing such functions and may also include multiple devices or components (e.g., when a device has remote access to a network by tethering to another device—e.g., using the other device as a relay—both devices taken together may be considered a single mobile device). The processor according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

As used herein, the term “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

As used herein, the term “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

As used herein, in dual connectivity mode in a communication network/system, the term “master node”, or Master Cell Group (MCG) may function as an anchor with which a UE may perform initial registration with. The master node or MCG may also add one or more secondary nodes or Secondary Cell Group (SCG). The master node provides control plane connection to the core network in case of dual connectivity. The master node belongs to a lower RAT and the secondary node belongs to a higher RAT.

As used herein, in dual connectivity mode in a communication network, the term secondary node or secondary cell group may refer, for example, to a node that may not have control plane connection to the core network but provides additional resources to a UE.

As used herein, in dual connectivity mode in a communication network, the term “other potential secondary nodes” may refer, for example, to one or more of the secondary nodes to which the master node sends an addition request to, to act as a serving secondary node.

As used herein, fallback secondary node in a dual connectivity mode may refer, for example, to a secondary node that a UE may connect with after the failure of a secondary node that the UE may already be connected with. The fallback secondary node may include a pre-configured backup secondary node.

As used herein, the term validity timer may refer, for example, to a timer that is associated with the validity conditions of a fallback secondary node.

As used herein, the random access channel (RACH) procedure may refer, for example, to an uplink transmission used by a UE to initiate synchronization with any base station such as a MN or SN node.

As used herein, the term “UPF” or “User Plane Function”, may include a communication network element that supports features and capabilities to facilitate user plane operations such as, without limitation to, packet routing and forwarding, interconnection to the data network, policy enforcement and data buffering.

As used herein, the term “AMF” or “Access and Mobility management Function” (AMF) may include a communication network element that supports features and capabilities to terminate control plane of different access networks onto the core network and control which UEs can access the core network to exchange traffic with data network.

As used herein, the term “SGW” or “Serving Gateway”, may include a communication network element that may route user data packets and may be responsible for inter-node-handovers in the user plane and may provide mobility between LTE and other types of networks.

As used herein, the term “MME” or “Mobility Management Entity”, may include a communication network element that may provide mobility and session management for communication networks and may support subscriber authentication, roaming and handovers to other networks.

As used herein, secondary node addition may refer, for example, to a process when a UE is only connected to a master node and the master node provides a set of secondary node configuration(s) along with associated execution conditions which the UE may evaluate. When an execution condition meets, the UE applies that secondary node configuration. The UE and the master node release the remaining secondary node configurations. The UE would therefore be connected to the master node and the secondary node in dual connectivity mode.

As used herein, secondary node change may refer, for example, to a process when a UE may already be connected to the master node and the secondary node in dual connectivity mode. The master node may provide a set of secondary node configuration(s) along with associated execution conditions which the UE may evaluate. When an execution condition meets, the UE changes the secondary node and applies that secondary node configuration and both UE and the master node release rest of the secondary node configuration(s). The UE would therefore be connected to the master node and another secondary node (changed) in dual connectivity mode.

In the following detailed description, reference is made to the accompanying drawings that form a part hereof, and in which are shown by way of illustration referring to various example embodiments in which the disclosure may be practiced. These example embodiments are described in sufficient detail to enable those skilled in the art to practice the disclosure, and it is to be understood that various embodiments may be utilized and that changes may be made without departing from the scope of the present disclosure. The following description is, therefore, not to be taken in a limiting sense.

As per the current research norms and industry trends, there are multiple options being talked about for initial 6G deployments including both existing Non-standalone and Standalone architecture options as well as new NSA architecture options. Below are possible (but not limited to), and easier to deploy, network architecture options for initial 6G deployment:—
NSA<Core Network: EPC, RAN: LTE as MCG+6G as SCG>;
NSA<Core Network: 5GC, RAN: NR as MCG+6G as SCG>; and
NSA<Core Network: 5GC, RAN: 6G as MCG+NR as SCG>.

In terms of spectrum, with the dawn of beyond 5G and towards 6G era, the demand is expected to be even higher than those of the previous generations due to emergence of exhaustive & complex new use-cases as well as need to enhance existing ones. These use-cases demand very high capacity and hence the need to move into even higher frequency ranges. Below are the expected candidate frequencies to play a role as part of the broader 6G spectrum context:—
sub-1 GHz spectrum such as 600/700 MHz;
mid-band spectrum such as 3.5/4.5/6 GHz;
centimetric spectrum such as 7-20 GHz;
mmW spectrum such as 26/28/40 GHz; and
sub-THz spectrum 92-300 GHz.

Further, such higher frequency ranges are prone to multiple disadvantages, due to their inherent characteristics, such as being affected by diffraction & material penetration, being affected by reflection & scattering, high attenuation, oxygen absorption, requiring large bandwidths, large antenna arrays, beamforming & spatial consistency, propagation loss, absorption loss, small & large scale fading etc.

Equipped with the 5G experiences, the above example cons of higher frequency, inherently, will make the underlying 6G communication signal and channel links susceptible to frequent failures as well ranging across various types of causes(direct as well as indirect) such as beam failure, radio link failure by continuous out of sync at Physical layer, initial synchronization failure, random access failure, SINR degradation, high CRC decoding failure at Physical layer, high BLER, maximum retransmissions at RLC layer etc.

Further, stringent latency requirements specified in 6G wireless technology specifications ranges from 10-100 microseconds (while a latency of 1 ms is specified for 5G systems) to include & cater real-time health, safety, remote, industrial automation (also including AI/ML processing) support.

A user device, e.g., user equipment (UE), while operating in 6G spectrum (with initial deployment in non-standalone dual connectivity mode with LTE or NR as MN node), may face significant cellular link failure (caused by above cited spectrum characteristics) followed by post failure recovery mechanism(s) and their involved ‘signaling’ and ‘synchronization’ delays. Overall, this may cause degradation in terms of user experience (link failure with drop in bandwidth) & latency requirements, and negatively impacts real-time use cases in a significant way. With diverse 6G spectrum and a vision to meet further refined and stringent key performance indicators (KPIs) and/or key performance values (KVIs), thereby helping to realize true potential of 6G use-cases, changes may be required in the existing SCG(6G) failure handling procedures, as well as new methods, to achieve faster SCG(6G) link recovery to improve user-experience and aligning with the reduced latency requirement(s).

Various example embodiments provide a framework for faster 6G SCG link recovery by making an efficient use of the conditional Pscell configuration(s) aspects within CPA and CPC procedures as defined in ‘EN-DC’ and ‘MR-DC with 5GC’ in 3GPP, by pre-configuring a conditional fallback SN cell(s) and related configuration and handing procedure(s) and using the same effectively in the event of 6G SCG failure for fast SCG link recovery.

Accordingly, various example embodiments herein provide a framework for faster 6G SCG link recovery by making an efficient use of the conditional Pscell configuration(s) aspects within CPA & CPC procedures as defined in ‘EN-DC’ and ‘MR-DC with 5GC’ in 3GPP, by pre-configuring a conditional fallback SN cell(s) and related configuration and handing procedure(s) and using the same effectively in the event of 6G SCG failure for fast SCG link recovery.

Various example embodiments herein provide a framework for faster 6G SCG link recovery by making an efficient use of the conditional Pscell configuration(s) aspects within CPA and CPC procedures as defined in ‘EN-DC’ and ‘MR-DC with 5GC’ in 3GPP, by pre-configuring a conditional fallback SN cell(s) and related configuration and handing procedure(s) and using the same effectively in the event of 6G SCG failure for fast SCG link recovery.

The following abbreviations may be referred to herein:
SA: Standalone
NSA: Non-standalone
MCG: Master Cell Group
SCG: Secondary Cell Group
MN: Master Node
SN: Secondary Node
CPA: Conditional Pscell Addition
CPC: Conditional Pscell Change

As for a 6G base station in the form of a Non-Standalone (NSA) architecture wherein, as per an embodiment, a 4G base station; e.g., LTE (eNB), can serve as a Master Node (MN) of the Master Cell Group (MCG) which interacts with the Evolved Packet Core (EPC) as the Core Network (CN) entity for all communication links related, but not limited to, to authentication, security, signaling and data path configurations.

In an example embodiment herein, a 5G base station (e.g., NR (gNB)), that can serve as a MN of the MCG, interacts with the 5th Generation Core Network (5GC) as the CN entity for all communication links related to, but not limited to, authentication, security, signaling and data path configurations.

Embodiments herein disclose a 6G base station (e.g., 6gNB), that may serve as a Secondary Node (SN) of the Secondary Cell Group (SCG) which works in close coordination with the MN (either 4G or 5G) for all cellular and data path configuration(s) communication taking place between MN & SN with a user equipment (UE).

Examples of the frequency ranges include, but are not limited to, sub-1 GHz spectrum, mid-band spectrum, centimetric spectrum, mmW spectrum and (sub) THz spectrum. The spectrum, especially in higher frequency ranges, are prone to multiple disadvantages, due to their inherent signal and channel characteristics. Further, equipped with the 5G deployment experiences worldwide, the cons of using higher frequency ranges as communication link (for 6G), makes the underlying communication signals and channels susceptible to frequent failures ranging across various types of direct as well as indirect cause(s), and finally may lead to SCG failure.

Further, 6G communication technology specification have to meet stringent latency value(s) of 10 to 100 microseconds as per its Key Performance Indicators (KPIs).

The current action(s) of MN, defined in 3GPP systems, upon reception of SCG failure from the UE and related recovery and/or reconfiguration mechanism(s) follows as below:—
the UE informs MN about SCG failure via RRC message;
the MN may decide to keep the SN/SCG and wait for SN condition to improve before reconfiguring it again for the UE (during this time ongoing data session shifts on—the MN leg only); or
the MN may decide to change the SN/SCG based on either blind/UE measurement, and hence need to perform complete SN Addition->Reconfiguration->Sync (by UE)->data path change related end to end Signalling; or
the MN may decide to release the SN/SCG, and then, the MN may again go ahead with an entire new sequence of SN addition later.

The above may lead to a considerable RRC signaling overhead as well as introduced interruption time and reduced bandwidth for the ongoing data/communication session, thereby degrading the user-experience in terms of bandwidth and increased latency.

Various example herein provide a framework for faster 6G SCG link recovery, by making an efficient use of the existing condition Pscell configuration(s) aspects within conditional Pscell addition(CPA) & conditional Pscell change(CPC) procedural framework as defined in ‘EN-DC’ and ‘MR-DC with 5GC’ procedures in 3GPP(37.340), by pre-configuring conditional fallback SN cell(s), along with 6G SCG cell(s), with an associated validity and to be used in the event of 6G SCG failure.

During the 6G SCG configuration, as part of a NSA architecture with either 4G or 5G as MN, when the UE is in a RRC connected state with MN (LTE or NR) and before the NW has configured the UE with CPA/CPC Pscell(s) configuration, the MN may identify a “candidate fallback SN” which may be used for faster SCG link recovery in the event of a 6G SCG failure.

This can be achieved in the following ways:—

In an example embodiment, a MN may configure an ‘inter RAT’ measurement configuration & reporting via event B1 for the UE to report the best IRAT neighbor cell present.

In an example embodiment herein, a MN may configure an ‘intra/inter-frequency’ measurement configuration & reporting via event A3/A4 for the UE to report the best neighbor cell present.

In an example embodiment herein, a MN can reserve a SN cell (as a candidate fallback SN) specifically to serve as a node for fast SCG link recovery for 6G NSA users in case of 6G SCG failure.

A MN may prefer a NR SN in sub-6 TDD or mmW spectrum over sub-6 FDD NR cell, due to higher bandwidth supported, as a candidate for fallback SN.

In an embodiment, in a method for conditional 6G SCG addition(CPA) with a LTE MCG in NSA architecture deployment, wherein a LTE MN is configuring a candidate fallback SN along with the conditional Pscell addition configuration for the 6G SCG NSA addition, the MN may initiate an Addition Request to the conditional 6G SN cell(s) asking for resource reservation for the UE, while sharing the UE context and related information to the 6G SN cell(s). Additionally, the MN may send an Addition Request to an identified candidate fallback SN as well. The requested 6G SN cell(s) as well as the candidate fallback SN cell confirms and acknowledges the addition request to MN via Addition Request Acknowledge signaling. The MN may include the fallback SN configuration along with configuration of 6G SN cell(s) as part of conditional Pscell addition configuration via RRCConnectionReconfiguration message towards the UE. The fallback SN configuration may be encapsulated in a separate SN RRCReconfiguration** message within a MN RRCConnectionReconfiguration* container inside the actual RRCConnectionReconfiguration message from MN. The UE may respond with RRCConnectionReconfigurationComplete to the MN (upon successful validation of the configuration) and store the 6G SN cell(s) configuration for 6G SCG addition purposes, as well as fallback SN cell configuration to be used later in the event of SCG failure. The UE may send a RRCConnectionReconfigurationComplete* message to the MN (upon meeting the execution condition for a 6G SN cell) indicating this 6G SN cell as serving 6G SCG to this UE now. The MN may release the other conditional 6G SN cell(s) but retain the fallback SN configuration. A common procedure of RACH on serving SN cell (in this case, it may be 6G SN) followed by the required data path update procedure between MN, SN and CN as defined in 3GPP may be performed.

In an embodiment, in a method for conditional 6G SCG addition (CPA) with a NR MCG in NSA architecture deployment, wherein a NR MN is configuring a candidate fallback SN along with the conditional Pscell addition configuration for the 6G SCG NSA addition, the MN may initiate an Addition Request to the conditional 6G SN cell(s) asking for resource reservation for the UE while sharing the UE context and related information to the 6G SN cell(s). Additionally, the MN may send an Addition Request to an identified candidate fallback SN as well. The requested 6G SN cell(s) as well as the candidate fallback SN cell confirms and acknowledges the addition request to the MN via Addition Request Acknowledge signaling. The MN may include the fallback SN configuration along with configuration of 6G SN cell(s) as part of conditional Pscell addition configuration via RRCReconfiguration message towards the UE. The fallback SN configuration may be encapsulated in a separate SN RRCReconfiguration** message within a MN RRCReconfiguration* container inside the actual RRCReconfiguration message from the MN. The UE ma respond with RRCReconfigurationComplete to the MN (upon successful validation of the configuration) and store the 6G SN cell(s) configuration for 6G SCG addition purposes as well as fallback SN cell configuration to be used later in the event of SCG failure. The UE may send a RRCReconfigurationComplete* message to the MN (upon meeting the execution condition for a 6G SN cell) indicating this 6G SN cell as serving 6G SCG to this UE now. The MN may release the other conditional 6G SN cell(s) but retain the fallback SN configuration. A common procedure of RACH on serving SN cell (in this case, it will be 6G SN) followed by the required data path update procedure between the MN, the SN and the CN as defined in 3GPP may be performed.

In an embodiment, in a method for conditional 6G SCG change (CPC) with a LTE MCG in NSA architecture deployment, wherein a LTE MN is configuring a candidate fallback SN along with the conditional Pscell change configuration for the target 6G SCG NSA change, the MN may initiate an Addition Request to the target conditional 6G SN cell(s) asking for resource reservation for the UE while sharing the UE context and related information to the 6G SN cell(s). Additionally, the MN may send an Addition Request to an identified candidate fallback SN as well. The requested target 6G SN cell(s) as well as the candidate fallback SN cell confirms and acknowledges the addition request to the MN via Addition Request Acknowledge signaling. The MN may include the fallback SN configuration along with configuration of target 6G SN cell(s) as part of a conditional Pscell change configuration via RRCConnectionReconfiguration message towards the UE. The fallback SN configuration may be encapsulated in a separate SN RRCReconfiguration** message within a MN RRCConnectionReconfiguration* container inside the actual RRCConnectionReconfiguration message from the MN. The UE may respond with RRCConnectionReconfigurationComplete to the MN (upon successful validation of the configuration) and store the target 6G SN cell(s) configuration for 6G SCG change purpose as well as fallback SN cell configuration to be used later in the event of SCG failure. The UE may send a RRCConnectionReconfigurationComplete* message to the MN (upon meeting the execution condition for a target 6G SN cell change) indicating this 6G SN cell as target serving 6G SCG to this UE now. The MN may release the other conditional target 6G SN cell(s), but retain the fallback SN configuration. The MN may confirm to the target 6G SN cell by sending Reconfiguration Complete message. A common procedure of RACH on serving SN cell (in this case, it may be 6G SN) followed by the required SN status transfer, data path update and the UE context release procedure between the MN, the SN and the CN as defined in 3GPP may be performed. The disclosed sequence of fallback SN addition in 6G CPC is applicable to both MN initiated as well as SN initiated SN change procedure.

In an embodiment, in a method for conditional 6G SCG change(CPC) with a NR MCG in NSA architecture deployment, wherein a NR MN is configuring a candidate fallback SN along with the conditional Pscell change configuration for the target 6G SCG NSA change, the MN may initiate an Addition Request to the target conditional 6G SN cell(s) asking for resource reservation for the UE while sharing the UE context and related information to the 6G SN cell(s). Additionally, the MN may send an Addition Request to an identified candidate fallback SN as well. The requested target 6G SN cell(s) as well as the candidate fallback SN cell confirms and acknowledges the addition request to the MN via Addition Request Acknowledge signaling. The MN may include the fallback SN configuration along with configuration of target 6G SN cell(s) as part of conditional Pscell change configuration via RRCReconfiguration message towards the UE. The fallback SN configuration may be encapsulated in a separate SN RRCReconfiguration** message within a MN RRCReconfiguration* container inside the actual RRCReconfiguration message from the MN. The UE may respond with RRCReconfigurationComplete to MN (upon successful validation of the configuration) and store the target 6G SN cell(s) configuration for 6G SCG change purpose as well as fallback SN cell configuration to be used later in the event of SCG failure. The UE may send a RRCReconfigurationComplete* message to the MN (upon meeting the execution condition for a target 6G SN cell change) indicating this 6G SN cell as target serving 6G SCG to this UE now. The MN may release the other conditional target 6G SN cell(s), but retain the fallback SN configuration. The MN may confirm to the target 6G SN cell by sending the Reconfiguration Complete message. A common procedure of RACH on serving SN cell (in this case, it may be 6G SN) followed by the required SN status transfer, data path update and UE context release procedure between MN, SN and CN as defined in 3GPP, may be preformed. The disclosed sequence of fallback SN addition in 6G CPC is applicable to both MN initiated as well as SN initiated SN change procedure.

The fallback SN cell(s), as configured by the MN and stored by the UE to be used in the event of SCG failure, may be uniquely identifiable by the UE from the rest of the conditional Pscell(s) configuration send by the MN. This can be achieved by introducing a new information element (IE) as part of the RRC Reconfiguration namely “fallbackConfig-rXY” placed at top in the RRCReconfiguration* of the fallback SN cell(s). Upon reception of such a conditional configuration from the MN, the UE may store the fallback SN configuration as well along with the rest of the Pscell(s) configuration included in CPA or CPC configuration. The MN may also configure a validity timer namely “validityTimer-rXY”, associated to this fallback SN cell in its RRCReconfiguration*, and the UE may start this timer immediately upon successful storage of the fallback SN configuration.

The signalling and inclusion of conditional fallback SN configuration along with the conditional configuration of 6G SN cell(s) as part of the RRCConnectionReconfiguration message of the LTE MN:

RRCConnectionReconfiguration-vXY-IEs ::= SEQUENCE {

| | | |
|---|---|---|
| conditionalReconfiguration-r16 | ConditionalReconfiguration-rXY | OPTIONAL, -- Need ON |

}
ConditionalReconfiguration-rXY ::= SEQUENCE {

| | |
|---|---|
| condReconfigurationToAddModList-rXY | CondReconfigurationToAddModList-rXY |

OPTIONAL, -- Need ON
}
CondReconfigurationToAddModList-rXY ::= SEQUENCE (SIZE (1.. maxCondConfig-rXY)) OF
CondReconfigurationAddMod-rXY
CondReconfigurationAddMod-rXY ::= SEQUENCE {

| | |
|---|---|
| condReconfigurationId-rXY | CondReconfigurationId-rXY, //6G SN configuration for SCG |

addition/change

| | | |
|---|---|---|
| triggerConditionSN-rXY | SEQUENCE (SIZE (1..2)) OF MeasId | OPTIONAL, -- Need ON |

| | |
|---|---|
| condReconfigurationToApply-rXY | OCTET STRING (CONTAINING |
| RRCConnectionReconfiguration) | OPTIONAL,-- Cond CondReconfigurationAdd |

```
  ...,
  ...,
```

| condReconfigurationId-rXY | CondReconfigurationId-rXY, //fallback SN configuration | |
|---|---|---|
| fallbackConfig-rXY | ENUMERATED {true} | OPTIONAL, -- Cond CPA/CPC //identifies a |

configuration as fallback SN configuration

| | | |
|---|---|---|
| validityTimer-rXY | ENUMERATED {to be decided by MN} | OPTIONAL, -- Need OR |
| triggerConditionSN-rXY | SEQUENCE (SIZE (1..2)) OF MeasId | OPTIONAL, -- Need ON |

| | |
|---|---|
| condReconfigurationToApply-rXY | OCTET STRING (CONTAINING |
| RRCConnectionReconfiguration) | OPTIONAL,-- Cond CondReconfigurationAdd |

...,

The signalling and inclusion of conditional fallback SN configuration along with the conditional configuration of 6G SN cell(s) as part of the RRCReconfiguration message of NR MN:

RRCReconfiguration-vXY-IEs ::= SEQUENCE {

| | | |
|---|---|---|
| conditionalReconfiguration-rXY | ConditionalReconfiguration-rXY | OPTIONAL, -- Need ON |

}
ConditionalReconfiguration-rXY ::= SEQUENCE {

| | | |
|---|---|---|
| condReconfigToAddModList-rXY | CondReconfigToAddModList-rXY | OPTIONAL, -- Need ON |

}
CondReconfigToAddModList-rXY ::= SEQUENCE (SIZE (1.. maxNrofCondCells-rXY)) OF
CondReconfigToAddMod-rXY
CondReconfigToAddMod-rXY ::= SEQUENCE {

| condReconfigId-rXY | CondReconfigId-rXY, //6G SN configuration for SCG addition/change | |
|---|---|---|
| condExecutionCond-rXY | SEQUENCE (SIZE (1..2)) OF MeasId | OPTIONAL, -- Need M |

| | |
|---|---|
| condRRCReconfig-rXY | OCTET STRING (CONTAINING RRCReconfiguration) |

```
OPTIONAL,-- Cond CondReconfigAdd
  ...,
  ...,
```

| condReconfigId-rXY | CondReconfigId-rXY, //fallback SN configuration | |
|---|---|---|
| fallbackConfig-rXY | ENUMERATED {true} | OPTIONAL, -- Cond CPA/CPC //identifies a |

configuration as fallback SN configuration

| | | |
|---|---|---|
| validityTimer-rXY | ENUMERATED {to be decided by MN} | OPTIONAL, -- Need OR |
| condExecutionCond-rXY | SEQUENCE (SIZE (1..2)) OF MeasId | OPTIONAL, -- Need M |

| | |
|---|---|
| condRRCReconfig-rXY | OCTET STRING (CONTAINING RRCReconfiguration) |

OPTIONAL,-- Cond CondReconfigAdd
...,
}

In an embodiment, in a method for fallback SN configuration storage, measurement & reporting and validityTimer renewal/expiry handling, the UE may store the conditional configuration of the 6G SN cell(s) as well as the fallback SN configuration received from MN via CPA/CPC procedure. The UE starts to evaluate the 6G Pscell(s) execution condition for Pscell addition or change purpose. The UE (re)starts the validityTimer associated to the fallback SN configuration. The UE may inform MN about the 6G SN execution condition success via RRC signaling and corresponding 6G SCG should be active now. The MN may release the other 6G Pscell(s) configuration with the exception of fallback SN cell(s). The UE may release the other 6G Pscell(s) configuration with the exception of fallback SN cell(s). The 6G SCG addition/change procedure is successful, and the UE starts to operate in 6G NSA mode either with LTE MN or NR MN. Since (re)start of the validityTimer, the UE may keep monitoring if the timer has expired yet.

If the timer has expired, the UE may inform the MN about the validityTimer expiry via a layer L3 or L2 or L1 signaling. The UE may release the fallback SN configuration and delete associated timer. MN may release the fallback SN resources. After successful 6G NSA activation, the UE may perform measurement and reporting for the fallback SN as per measurement configuration provided by the MN. Based on the UE's measurement report about fallback SN, the MN may decide to restart or renew the validityTimer with a new value. If the MN has requested the UE to renew the timer value, the UE may restart the validityTimer with the new value, else if the MN has requested the UE to restart the time, the UE may restart the validityTimer with the same value as before.

In the event of 6G SCG failure due to any of the aforementioned causes, the UE may indicate the same to the MN by sending a proposed message SCGFailurelnformation6G and include the fields (but not limited to) failure cause value, measurement results available according to current measurement configuration of both MN and 6G SN (if any), if the UE has a fallback SN configuration stored with an active/valid validityTimer running, a new IE namely “fallbackConfigPresent” (as True) may be included to indicate availability of a non-expired fallback SN, and else, 6G SCG failure may be handled on similar lines to 3GPP section 7.7 of 37.340.

| | |
|---|---|
| SCGFailureInformation6G ::= | SEQUENCE { |
| criticalExtensions | CHOICE { |
| scgFailureInformation | SCGFailureInformation-IEs, |
| criticalExtensionsFuture | SEQUENCE { } |

...

| | |
|---|---|
| fallbackConfigPresent | ENUMERATED {true} OPTIONAL |

}
}

In an embodiment, when the MN receives SCGFailurelnformation6G including “fallbackConfigPresent”, the MN may hold the 6G SN/SCG to ensure data path transfer and data recovery.

The UE may start evaluating the fallback SN execution condition. If the execution condition is successful, the UE may discard the validityTimer and apply the fallback SN configuration. the UE may send RRC(Connection)ReconfigurationComplete* message to the MN including RRCReconfigurationComplete* containing fallback SN RRCReconfigurationComplete**. Else, if the execution condition is failed, the UE may send a proposed SCGFailurelnformationFB message including (but not limited to) a new IE “execCondFail” (as True). Upon reception of which, the UE and the MN may release the fallback SN configuration and the MN may perform fresh SN/SCG configuration.

| | |
|---|---|
| SCGFailureInformationFB ::= | SEQUENCE {//for fallback SN |

...

| | |
|---|---|
| FailureReportSCG ::= | SEQUENCE { |
| failureType | ENUMERATED (execCondFail, ... |

}
}

Upon successful reception of RRCReconfigurationComplete* from the UE, the MN may indicate Reconfiguration Complete to the fallback SN and release the previous serving 6G SCG (if any saved). Upon success of the fallback SN's execution condition and application of the associated configuration, the UE may perform sync with fallback SN via RACH procedure. The last successful data packet sequence number (SN) report may be exchanged from the 6G SCG to the fallback SN for any possible data recovery. The data forwarding path may be updated between the MN and the CN towards the fallback SN as the new serving SCG. According to the updated data path, E-RAB (if MN is LTE) else PDU Session Resource (if MN is NR) Modification Indication exchange between MN and CN, followed by UE Context Release at failed 6G SCG (if any) may take place. As a backup plan, the MN may already reserve another SN/SCG configuration via SN Addition procedure in the backend while waiting for the UE's response to fallback SN execution condition evaluation, which the MN may release or configure based on the UE's fallback SN evaluation success or failure indication. To ensure and aid faster SCG link recovery without data packet loss, the NW may configure the same PDCP type (for the data bearer) on fallback SN as active 6G SN/SCG had. It can be a new “6gPDCPType”.

Pre-configuring the fallback SN cell(s) avoids signaling delays post SCG failure as well as fallback SN should be able to provide highest bandwidth corresponding to the UE's current data needs as was being served by the 6G SCG. Accordingly, the MN may choose to configure one or more fallback SNs. To a 6G SCG in high frequency ((sub)THz), a fallback SN can be a lower/shared spectrum 6G cell, a NR mmW cell, a NR TDD cell, a NR FDD cell and so on with reducing priority based on lower the bandwidth configurable. The MN may use/configure some enhanced criteria, before configuring a conditional fallback SN to the UE, such as ‘number of continuous SCG failure(s)’ within a stipulated time frame etc.

In an embodiment, a criteria like ‘number of continuous SCG failure(s)’ before applying the fallback SN may be configured as part of its execution condition itself.

From SCG failure mitigation point of view, from the conditional addition/change of Pscell(6G), a UE may prioritize a shared spectrum 6G SN over (sub)THz 6G (if both are configured) based on some UE side specific conditions such as by considering the remaining UL transmission power for the SN leg, in case, the NIN leg is utilizing high amounts of power while operating under Dynamic Power Sharing (DPS) scenario. From 6G (sub)THz SCG failure mitigation point of view, the NW may configure a lower frequency SUL carrier, in SCG configuration, for the UE to perform RACH on the SCG cell with a greater probability of success.

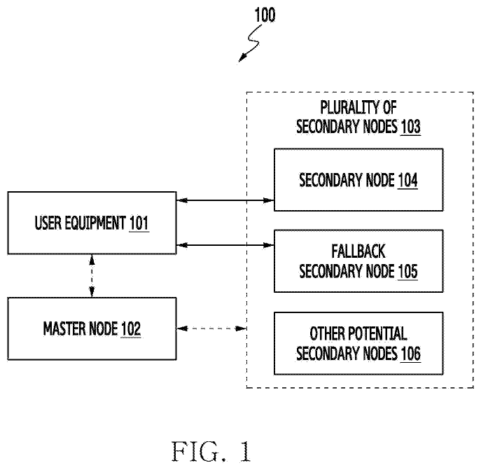

FIG. 1 is a block diagram illustrating an example system 100 for secondary node recovery in non-standalone communication system according to various embodiments. The system may comprise a User Equipment (UE) 101, a master node 102, a plurality of secondary nodes 103 where the various components may be implemented as software (e.g., executable program instructions) and/or hardware (e.g., circuitry) components or Virtualized Network Functions (VNF) or Containerized Network Functions (CNF) or any other forms.

In an embodiment, the plurality of secondary nodes 103 may comprise a secondary node 104, a fallback secondary node 105 and other potential secondary nodes 106. The plurality of secondary nodes 103 may belong to one of, a same or a different Radio Access Technology (RAT) as the master node 102. In an embodiment, the plurality of secondary nodes 103 may belong to same RAT as that of the master node 102. In an embodiment, the plurality of secondary nodes 103 may belong to different RAT as that of the master node 102. For example, the master node 102 may belong to 4G (Long-Term Evaluation (LTE)) or 5G (New Radio (NR)) RAT and the plurality of secondary nodes 103 may belong to a 5G/6G RAT or 6G RAT respectively. The UE 101 may be connected to the secondary node 104 and the fallback secondary node 105. The master node 102 may be connected the plurality of secondary nodes 103.

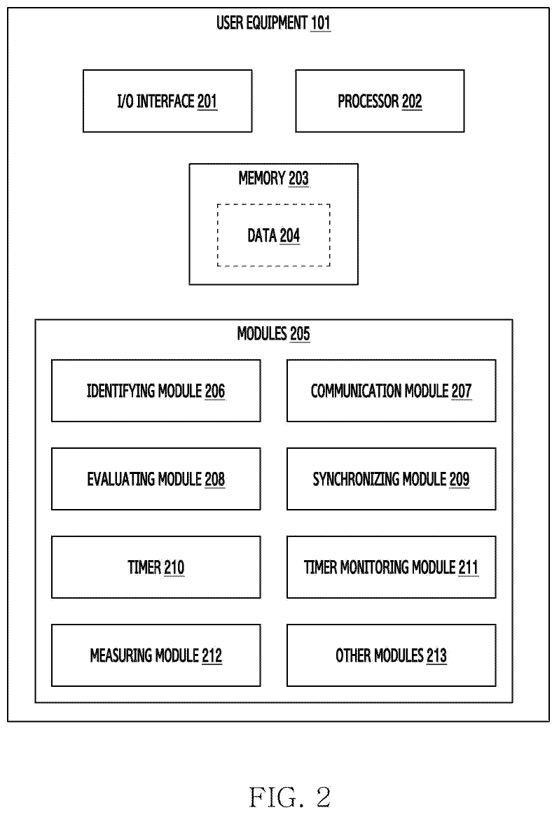

FIG. 2 is a block diagram illustrating an example configuration of the UE 101 according to various embodiments. The UE 101 may comprise a processor (e.g., including processing circuitry) 202, an input/output (I/O) interface (e.g., including I/O circuitry) 201, a memory 203 and modules (e.g., including various circuitry and/or executable program instructions) 205. The memory 203 may further comprise data 204. The modules 205 may further comprise modules such as without limitation to, an identifying module 206, a communication module 207, an evaluating module 208, a synchronizing module 209, a timer 210, a timer monitoring module 211, a measuring module 212 and other modules 213, each of which may include various circuitry and/or executable program instructions).

In an embodiment, the data 204 may include various temporary data and files generated by the modules 205. The data 204 may comprise fallback secondary configuration received by the UE 101 from the master node 102.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the modules 205 may be configured as stand-alone hardware computing units. In an embodiment, the other modules 213 may be used to perform various miscellaneous functionalities of the ULE 101. It will be appreciated that such the modules 205 may be represented as a single module or a combination of different modules.

In an embodiment, the identifying module 206 may be configured to identify failure in the secondary node 104. A failure in the secondary node 104 may be caused due to one of beam failure, radio link failure by continuous out of synchronization at physical layer, initial synchronization failure, random access failure, Signal to Interference and Noise Ratio (SINR) degradation, high Cyclic Redundancy Check (CRC) decoding failure at physical layer, high Block Error Rate (BLER), maximum retransmissions at Radio Link Control (RLC) layer etc. Reasons for such failures may include diffraction and material penetration of communication signals, reflection and scattering of communication signals, high attenuation of high frequency communication signals, oxygen absorption of communication signals, propagation loss of communication signals, absorption loss of communication signals, small and large scale fading of communication signals etc.

In an embodiment, the communication module 207 may be configured to receive and transmit, without limitation to, one or more messages or notifications or data from the master node 102, the secondary node 104 and the fallback secondary node 105. The communication module 207 may be configured to send to the master node 102 information related to failure of the secondary node 104 and an indication of a presence of the fallback secondary node configuration. The communication module 207 may be configured to send to the master node 102, Radio Resource Control (RRC) reconfiguration complete message to connect to the fallback secondary node 105 based on evaluation. The communication module 207 may be configured to report one or more of a plurality of connection parameters associated with the fallback secondary node 105, to the master node 102 until an expiry of the validity timer. The communication module 207 may be configured to send to the master node 102, information indicating the expiry of the validity timer.

In an embodiment, the plurality of connection parameters comprises, without limitation to, signal strength measurement parameters associated with the fallback secondary node 105 and a signal quality associated with the fallback secondary node 105.

In an embodiment, the evaluating module 208 may be configured to evaluate an execution condition of the fallback secondary node 105 based on a plurality of connection parameters. Evaluating execution condition of the fallback secondary node 105 comprises determining that each of a plurality of connection parameters associated with the fallback secondary node 105 are within their respective threshold ranges.

In an embodiment, the synchronizing module 209 may be configured to synchronize the UE 101 with the fallback secondary node 105 via Random Access Channel (RACH) procedure.

In an embodiment, a validity timer associated with the fallback secondary node 105 may be initiated by timer 210.

In an embodiment, the measuring module 212 may be configured to measure one or more of the plurality of connection parameters associated with the fallback secondary node 105, to the master node 102 until an expiry of the validity timer.

In an embodiment, the timer 210 may receive a message from the master node 102 to renew/restart the validity timer.

In an embodiment, the timer monitoring module 211 may be configured to monitor the validity timer. In an embodiment, the timer monitoring module 211 sends a message indicating the expiry of the validity timer to the master node 102.

In an embodiment, the fallback secondary configuration stored in the memory 204 as part of the data 204 may be released when the validity timer expires.

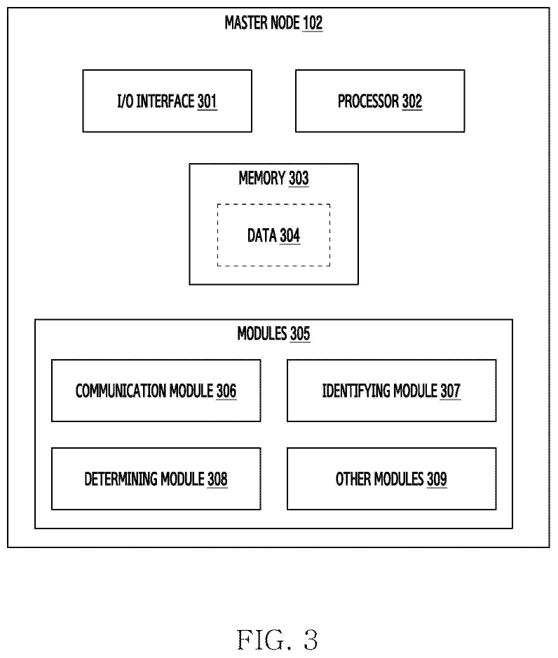

FIG. 3 is a block diagram illustrating an example configuration of a master node 102, according to various embodiments. The master node 102 may comprise a processor (e.g., including processing circuitry) 302, an input/output (I/O) interface (e.g., including I/O circuitry) 301, a memory 303 and modules (e.g., including various circuitry and/or executable program instructions) 305. The memory 203 may further comprise data 304. The modules 305 may further comprise modules such as without limitation to, a communication module 306, an identifying module 307, a determining module 308 and other modules 309, each of which may include various circuitry and/or executable program instructions.

In an embodiment, the data 304 may include various temporary data and files generated by the modules 305. The data 304 may comprise configuration parameters of the plurality of secondary nodes 103.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the modules 305 may be configured as stand-alone hardware computing units. In an embodiment, the other modules 309 may be used to perform various miscellaneous functionalities of the master node 102. It will be appreciated that such the modules 305 may be represented as a single module or a combination of different modules.

In an embodiment, the communication module 306 may be configured to send a secondary node addition request to a plurality of secondary nodes 103. The communication module 306 may be configured to receive configuration parameters of the plurality of secondary nodes 103.

In an embodiment, the communication module 306 may be configured to send to the UE 101, a fallback secondary node configuration for connecting the UE 101 with the fallback secondary node 105 in an event of a failure of the secondary node 104 connected with the UE 101.

In an embodiment, the communication module 306 may be configured to receive from the UE 101, information related to failure of the secondary node 104 and an indication of the presence of a valid fallback secondary node configuration. The communication module 306 may be configured to receive from the UE 101, an RRC reconfiguration complete message to connect the UE 101 to the fallback secondary node 105, based on evaluation of the fallback secondary node 105 by the UE 101. The communication module 306 may be configured to send an acknowledgement indicating RRC reconfiguration complete to the fallback secondary node 105.

In an embodiment, the communication module 306 may be configured to send a release request message to the secondary node 104 to release the secondary node's 104 connection with the UE 101 and to release any resources previously allocated to the UE 101. In an embodiment, the communication module 306 may be configured to receive from the UE 101, information indicating expiration of the validity timer. The communication module 306 may be configured to send to the fallback secondary node 105, a request to release resources reserved for the UE 101, upon receiving an indication of expiration of the validity timer.

In an embodiment, the communication module 306 may be configured to send to the fallback secondary node 105, a request to reserve resources for the UE 101. The communication module 306 may be configured to receive from the fallback secondary node 105, a confirmation indicating reservation of resources for the UE 101.

In an embodiment, the identifying module 307 may be configured to identify the fallback secondary node 105 for the UE 101 from the plurality of secondary nodes 103. The identifying module 307 may identify the fallback secondary node 105 based on one of: inter-RAT measurement, inter-RAT frequency or intra RAT frequency. The identifying module 307 may independently identify one or more than secondary nodes of the plurality of secondary nodes 103 as the fallback secondary node 105 based on the RAT they belong to. For example, the identifying module 307 may prefer a 6G centimetric secondary node over sub-Tera-Hertz secondary node, a New Radio secondary node in millimeter wave or sub-6 Time Division Duplex (TDD) spectrum secondary node over sub-6 Frequency Division Duplex (FDD) new radio secondary node.

In an embodiment, the determining module 308 may be configured to receive from the UE 101, a report of one or more of a plurality of connection parameters associated with the fallback secondary node 105. The determining module 308 may be configured to determine if the one or more of the plurality of connection parameters are within their respective threshold ranges. If the one or more of the plurality of connection parameters are within their respective threshold ranges, the determining module 308 may be configured to send a message to the UE 101 to renew/restart the validity timer.

In an embodiment, the plurality of connection parameters may comprise, without limitation, signal strength measurement parameters associated with the fallback secondary node 105 and a signal quality associated with the fallback secondary node 105 etc.

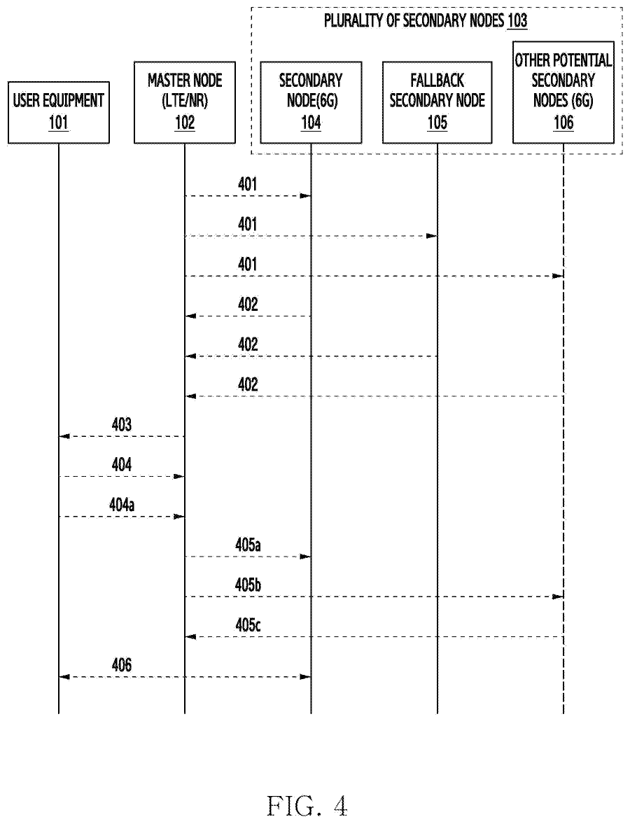

FIG. 4 is a signal flow diagram illustrating example operations of secondary node 104 addition with an LTE/NR master node in non-standalone architecture deployment and configuring of fallback secondary node 105, according to various embodiments.

In an embodiment, the master node 102 may belong to 4G/5G RAT and the plurality of secondary nodes 103 may belong to a 5G/6G RAT or 6G RAT respectively.

In an embodiment, when the master node 102 belongs to a 4G RAT (LTE) and the plurality of secondary nodes 103 belong to a 5G/6G RAT:

At step 401, the master node 102 requests for resource reservation for the UE 101 via an addition request message to the plurality of secondary nodes 103. The master node 102 may also share a UE context and related information to the plurality of secondary nodes 103. The master node 102 may also send a request for resource reservation for the UE 101 via an addition request message to the identified fallback secondary node 105. The addition request message is sent to pre-configure the fallback secondary node 105 in case the secondary node 104 fails.

At step 402, the secondary node 104, the other potential secondary nodes 106 and the fallback secondary node 105 confirm and acknowledge the addition request to the master node 102 via addition request acknowledge signaling.

At step 403, the master node 102 may send RRCConnectionReconfiguration message to the UE 101 which includes the fallback secondary node configuration along with secondary node 104 and other potential secondary nodes 106 configuration as part of secondary node addition configuration. The fallback SN configuration may be sent via a secondary node-RRCReconfiguration** message within a master node-RRCConnectionReconfiguration* container inside the RRCConnectionReconfiguration message from master node 102 to the UE 101.

At step 404, the UE 101 may send RRCConnectionReconfigurationComplete to the master node 102, upon successful validation of the configuration. The UE 101 may store the secondary node 104 configuration for 5G/6G secondary SCG addition. The UE 101 may store the fallback secondary node configuration to be used in the event of failure of secondary node 104.

At step 404a, the UE 101 may send an RRCConnectionReconfigurationComplete* message to the master node 102, if the secondary node 104 meets the execution condition for a 5G/6G secondary node cell, indicating the secondary node 104 as the serving secondary node to the UE 101.

At step 405a, the master node 102 may send an reconfigurationcomplete message to the secondary node 104. At step 405b, the master node 102 may send a releaserequest message to the other potential secondary nodes 106, to release the resources reserved for the UE 101. At step 405c, the master node 102 may receive releaserequest-acknowledgement from the other potential secondary nodes 106. In an embodiment, the master node 102 may retain the fallback secondary node configuration.

At step 406, RACH procedure between the UE 101 and the secondary node 104 may take place. In an embodiment, the above steps may be followed by required data path update procedure between master node 102, secondary node 104, UE 101 and other communication network components as defined in 3^{rd} Generation Partnership Project (3GPP).

In an embodiment, when the master node 102 belongs to a 5G RAT (NR) and the plurality of secondary nodes 103 may belong to a 6G RAT:

At step 401, the master node 102 requests for resource reservation for the UE 101 via an addition request message to the secondary node 104 and the other potential secondary nodes 106. The master node 102 may also share the UE context and related information to the secondary node 104 and the other potential secondary nodes 106. The master node 102 may also send a request for resource reservation for the UE 101 via an addition request message to the identified fallback secondary node 105.

At step 402, the secondary node 104, the other potential secondary nodes 106 and the fallback secondary node 105 confirm and acknowledge the addition request to the master node 102 via addition request acknowledge signaling.

As a further to the above step, the master node 102 may send Xn-U address indication to the secondary node 104, the other potential secondary nodes 106 and the fallback secondary node 105

At step 403, the master node 102 may send RRCReconfiguration message to the UE 101 which includes the fallback secondary node configuration along with secondary node 104 and other potential secondary nodes 106 configuration as part of secondary node addition configuration. The fallback SN configuration may be send via a secondary node-RRCReconfiguration** message within a master node-RRCReconfiguration* container inside the RRCReconfiguration message from master node 102 to the UE 101.

At step 404, the UE 101 may send RRCReconfigurationComplete to the master node 102, upon successful validation of the configuration. The UE 101 may store the secondary node 104 configuration for 6G secondary SCG addition. The UE 101 may store the fallback secondary node configuration to be used in the event of failure of secondary node 104.

At step 404a, the UE 101 may send an RRCReconfigurationComplete* message to the master node 102, if the secondary node 104 meets the execution condition for a 6G secondary node cell, indicating the secondary node 104 as the serving secondary node to the UE 101.

At step 405a, the master node 102 may send a reconfigurationcomplete message to the secondary node 104. At step 405b, the master node 102 may send a releaserequest message to the other potential secondary nodes 106, to release the resources reserved for the UTE 101. At step 405c, the master node 102 may receive releaserequest-acknowledgement from the other potential secondary nodes 106. In an embodiment, the master node 102 may retain the fallback secondary node configuration.

At step 406, RACH procedure between the UE 101 and the secondary node 104 may take place. In an embodiment, the above steps may be followed by required data path update procedure between master node 102, secondary node 104, UE 101 and other communication network components as defined in 3^{rd} Generation Partnership Project (3GPP).

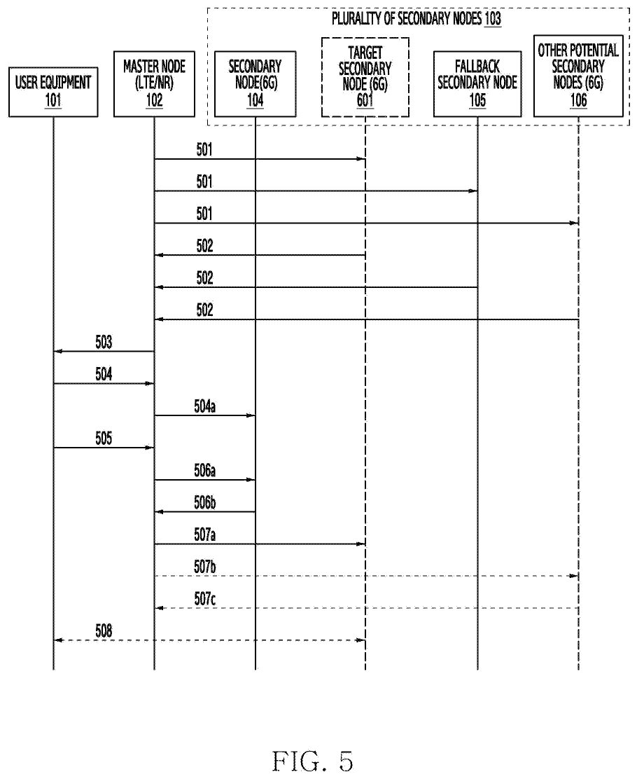

FIG. 5 is a signal flow diagram illustrating example operations of a 6G secondary node change with an LTE/NR master node 102 in non-standalone architecture deployment and configuring of fallback secondary node 105, according to various embodiments.

In an embodiment, the master node 102 may belong to 4G/5G RAT and the plurality of secondary nodes 103 may belong to a 5G/6G RAT or 6G RAT respectively.

In an embodiment, when the master node 102 belongs to a 4G RAT (LTE) and the plurality of secondary nodes 103 belong to a 5G/6G RAT:

At step 501, the master node 102 requests for resource reservation for the UE 101 via an addition request message to a target secondary node 601 and the other potential secondary nodes 106. The master node 102 may also share the UE context and related information to the secondary node 104 and the other potential secondary nodes 106. The master node 102 may also send a request for resource reservation for the UE 101 via an addition request message to the identified fallback secondary node 105.

At step 502, the target secondary node 601, the other potential secondary nodes 106 and the fallback secondary node 105 confirm and acknowledge the addition request to the master node 102 via addition request acknowledge signaling.

At step 503, the master node 102 may send RRCConnectionReconfiguration message to the UE 101 which includes the fallback secondary node configuration along with target secondary node 601 and other potential secondary nodes 106 configuration as part of secondary node addition configuration. The fallback SN configuration may be sent via a secondary node-RRCReconfiguration** message within a master node-RRCConnectionReconfiguration* container inside the RRCConnectionReconfiguration message from master node 102 to the UE 101.

At step 504, the UE 101 may send RRCConnectionReconfigurationComplete to the master node 102, upon successful validation of the configuration. The UE 101 may store the target secondary node configuration for 5G/6G secondary SCG change. The UE 101 may store the fallback secondary node configuration to be used in the event of failure of secondary node 104. At step 504a, the master node 102 indicates the address for data forwarding to the secondary node 104.

At step 505, the UE 101 may send an RRCConnectionReconfigurationComplete*message to the master node 102, if the target secondary node 601 meets the execution condition for a 5G/6G secondary node cell, indicating the target secondary node 601 as the serving secondary node to the UE 101.

At step 506a, the master node 102 sends releaserequest message to the secondary node 104, to release the resources reserved for the UE 101. At step 506b, the master node 102 may receive releaserequest-acknowledgement from the secondary node 104.

At step 507a, the master node 102 may send a reconfigurationcomplete message to the target secondary node 601. At step 507b, the master node 102 may send a releaserequest message to the other potential secondary nodes 106, to release the resources reserved for the UE 101. At step 507c, the master node 102 may receive releaserequest-acknowledgement from the other potential secondary nodes 106. In an embodiment, the master node 102 may retain the fallback secondary node configuration.

At step 508, RACH procedure between the UE 101 and the secondary node 104 may take place.

In an embodiment, when the master node 102 belongs to a 5G RAT (NR) and the plurality of secondary nodes 103 belong to a 6G RAT:

At step 501, the master node 102 requests for resource reservation for the UE 101 via an addition request message to a target secondary node 601 and the other potential secondary nodes 106. The master node 102 may also share the UE context and related information to the secondary node 104 and the other potential secondary nodes 106. The master node 102 may also send a request for resource reservation for the UE 101 via an addition request message to the identified fallback secondary node 105.

At step 502, the target secondary node 601, the other potential secondary nodes 106 and the fallback secondary node 105 confirm and acknowledge the addition request to the master node 102 via addition request acknowledge signaling.

At step 503, the master node 102 may send RRCReconfiguration message to the UE 101 which includes the fallback secondary node configuration along with target secondary node 601 and other potential secondary nodes configuration as part of secondary node addition configuration. The fallback SN configuration may be sent via a secondary node-RRCReconfiguration** message within a master node-RRCReconfiguration* container inside the RRCReconfiguration message from master node 102 to the UE 101.

At step 504, the UE 101 may send RRCReconfigurationComplete to the master node 102, upon successful validation of the configuration. The UE 101 may store the target secondary node configuration for 6G secondary SCG change. The UE 101 may store the fallback secondary node configuration to be used in the event of failure of secondary node 104. At step 504a, the master node 102 sends Xn-U address indication from the master node 102 to the secondary node 104.

At step 505, the UE 101 may send an RRCReconfigurationComplete* message to the master node 102, if the target secondary node 601 meets the execution condition for a 6G secondary node cell, indicating the target secondary node 601 as the serving secondary node to the UE 101.

At step 506a, the master node 102 sends releaserequest message to the secondary node 104, to release the resources reserved for the UE 101. At step 506b, the master node 102 may receive releaserequest-acknowledgement from the secondary node 104. As a further to the above step, the master node 102 may send Xn-U address indication to the secondary node 104.

At step 507a, the master node 102 may send a reconfigurationcomplete message to the target secondary node 601. At step 507b, the master node 102 may send a releaserequest message to the other potential secondary nodes 106, to release the resources reserved for the UE 101. At step 507c, the master node 102 may receive releaserequest-acknowledgement from the other potential secondary nodes 106. In an embodiment, the master node 102 may retain the fallback secondary node configuration.

At step 508, RACH procedure between the UE 101 and the secondary node 104 may take place.

In an embodiment, when the master node 102 belongs to a 4G RAT (LTE) and the plurality of secondary nodes 103 belong to a 5G/6G RAT: The master node 102 may configure an additional conditional RRC(Connection)Reconfiguration* message containing RRCReconfiguration** in the RRC(Connection)Reconfiguration message for the fallback secondary node 105, along other potential secondary nodes 106 conditional configuration as part of secondary node addition/change configuration.

In an embodiment, “CondReconfigurationId-rXY” may be used as an RRC reconfiguration container for secondary node addition/change in non-standalone architecture deployment and configuring of fallback secondary node. It may include fallback secondary node's 105 configuration.

The fallback secondary node 105 configuration may be identified by a new IE: “fallback Config-rXY, introduced as an element in the RRCReconfiguration* message. The “fallback Config-rXY” IE may aid in identifying whether or not a conditional RRC reconfiguration is a fallback secondary node, e.g., when fallback Config-rXY is set to ‘true’ it indicates that the secondary node configuration present is that of the fallback secondary node 105.

In an embodiment, upon reception of fallback secondary node's 105 configuration, the UE 101 may start an associated “validityTimer-rXY”. The “validity Timer-rXY” may be provided as part of fallback secondary node RRCReconfiguration* message. The valid/running state of “validityTimer-rXY” may be indicative of the presence of a valid fallback secondary conditional configuration.

In an embodiment, when the master node 102 belongs to a 5G RAT (NR) and the plurality of secondary nodes 103 belong to a 6G RAT:

The master node 102 may configure an additional conditional RRCReconfiguration* message containing RRCReconfiguration** in the RRCReconfiguration message for the fallback secondary node 105, along other potential secondary nodes 106 conditional configuration as part of secondary node addition/change configuration.

In an embodiment, “CondReconfigurationId-rXY” may be used as an RRC reconfiguration container for secondary node addition/change in non-standalone architecture deployment and configuring of fallback secondary node. It may include fallback secondary node's 105 configuration.

The fallback secondary node 105 configuration may be identified by a new IE “fallback Config-rXY” introduced as an element while sending RRCReconfiguration* message. The “fallback Config-rXY” IE may aid in identifying whether or not a conditional RRC reconfiguration is a fallback secondary node, e.g., when fallback Config-rXY is set to ‘true’ it indicate that the secondary node configuration present is that of the fallback secondary node 105.

In an embodiment, upon reception of fallback secondary node's 105 configuration, the UE 101 may start an associated “validityTimer-rXY”. The “validity Timer-rXY” may be provided as part of fallback secondary node RRCReconfiguration* message. The valid/running state of “validityTimer-rXY” may be indicative of the presence of a valid fallback secondary conditional configuration.

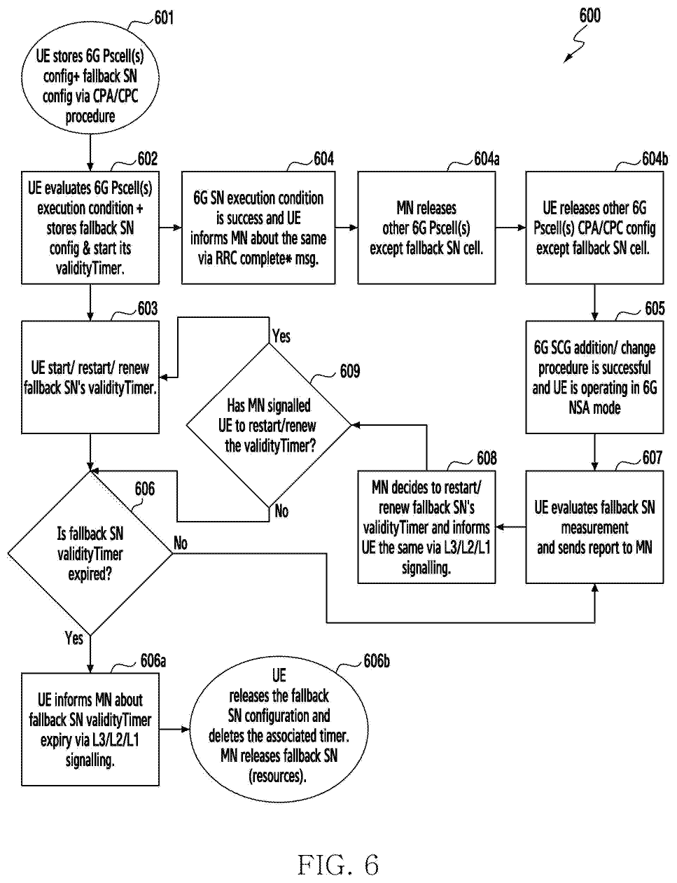

FIG. 6 is a flowchart illustrating an example method for fallback secondary node configuration storage, measurement, reporting and timer renewal/expiry handling, according to various embodiments.

In an embodiment, the master node 102 may belong to 4G/5G RAT and the plurality of secondary nodes 103 may belong to a 5G/6G RAT or 6G RAT respectively.

At step 601, the UE 101 may store the configuration of the secondary node 104 and the fallback secondary node configuration, received from the master node 102 via CPA/CPC procedure.

At step 602, the UE 101 may evaluate the execution condition of the secondary node 104, stores the fallback secondary node configuration and starts the validity timer.

At step 603, the UE 101 starts or restarts or renews a validity timer associated with the fallback secondary node 105.

At step 604, the UE 101 may inform the master node 102 about the secondary node 104 execution condition success via RRC signaling.

At step 604a, the master node 102 may release the other potential secondary node's 106 configurations with the exception of the fallback secondary node configuration.

At step 604b, the UE 101 may release the other potential secondary node's 106 configuration with the exception of the fallback secondary node configuration.

At step 605: the secondary node 104 is successfully added or changed and the UE 101 operates in NSA mode.

At step 606, the UE 101 monitors the validity timer from the step 603 for its expiry.

At step 606a, if the validity timer has expired, the UE 101 may inform the master node 102 via a layer L3 or L2 or L1 signaling.

At step 606b, the UE 101 may release the fallback secondary node configuration and delete associated validity timer. The master node 102 may release the resources allocated to the UE 101 in the fallback secondary node 105.

At step 607, after step 605, the UE 101 may perform measurement and reporting of the one or more of the plurality of connection parameters of the fallback secondary node 105 as per measurement configuration provided by the master node 102.

At step 608, based on the UE's 101 report regarding the one or more of the plurality of connection parameters of the fallback secondary node 105, the master node 102 may decide to restart or renew the validity timer with a new value.

At step 609, if the master node 102 has requested the UE 101 to renew the timer value, the UE 101 may restart the validity timer with the new value. In an embodiment, if master node 102 has requested the UE 101 to restart the validity timer, the UE 101 may restart the validity timer with same value as before. In an embodiment, the presence of the fallback secondary node configuration in the UE 101 may indicate that the fallback secondary node 105 is still valid.

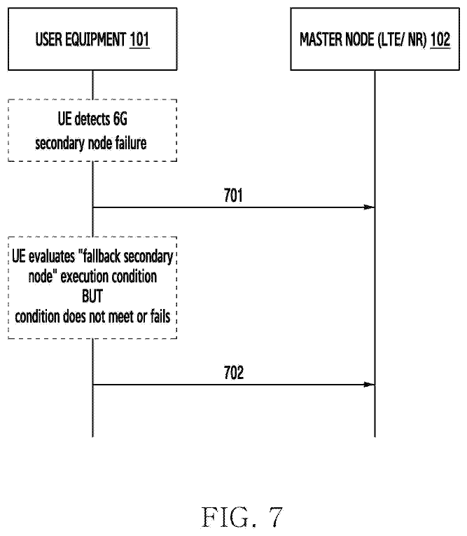

FIG. 7 is a signal flow diagram illustrating example operations between a UE 101 and a master node 102 in the event of failure of execution condition of fallback secondary node 105, according to various embodiments.

In an embodiment, the master node 102 may belong to 4G/5G RAT and the plurality of secondary nodes 103 may belong to a 5G/6G RAT or 6G RAT respectively.

In an embodiment, when the UE 101 detects secondary node 104 failure, at step 701, the UE 101 may indicate this to the master node 102 by sending, for example, without limitation to, SCGFailurelnformation6G message. SCGFailurelnformation6G may include: a failure cause value, one or more measurement results available according to current measurement configuration of both the master node 102 and secondary node 104.

In an embodiment, when the UE 101 evaluates the fallback secondary node 105 execution condition, but the conditions do not meet or the condition fails, at step 702, the UE 101 sends a new message SCGFailurelnformationFB to the master node 102 MN with a new IE “execCondFail”, indicating fallback secondary node 105 execution condition failure. The master node 102 may then perform steps for a fresh secondary node configuration.

In an embodiment, the SCGFailurelnformation6G may contain: “fallbackConfigPresent”, which may indicate to the master node 102 the availability of a non-expired valid fallback secondary node 105 configuration, SCGFailurelnformationFB, and “execCondFail”, which may that the failure of the execution condition of the fallback secondary node 105.

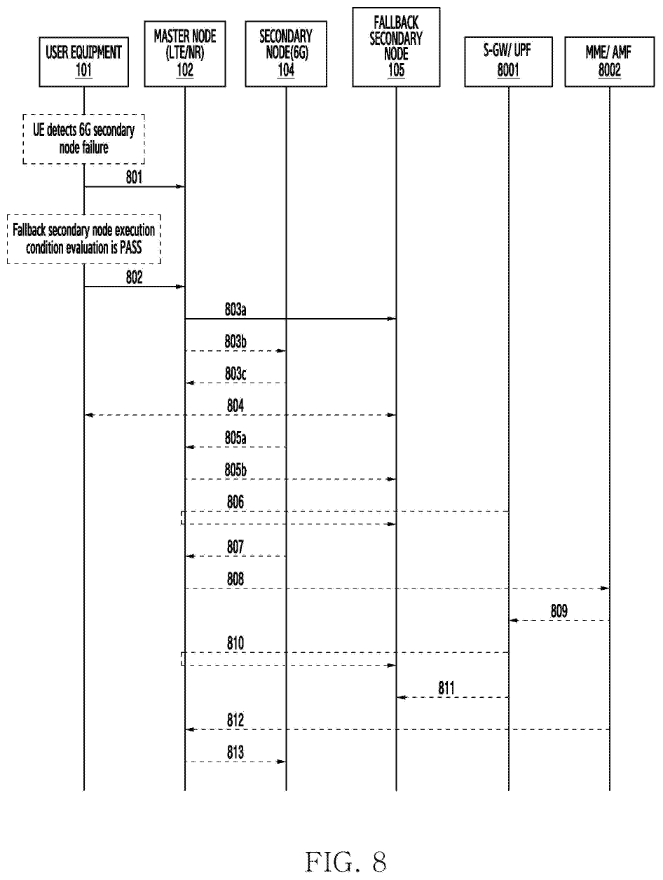

FIG. 8 is a signal flow diagram illustrating example operations in the event of failure of secondary node using valid fallback secondary node 105, execution condition of fallback secondary node 105 subsequent to failure of secondary node 104, according to various embodiments.

In an embodiment, the master node 102 may belong to 4G/5G RAT and the plurality of secondary nodes 103 may belong to a 5G/6G RAT or 6G RAT respectively.

In an embodiment, when UE 101, detects a failure of the secondary node 104, at step 801, the UE 101 sends, SCGFailurelnformation6G, including an indication: “fallbackConfigPresent”.

The master node 102, may then hold the secondary node 104, to ensure data path transfer and data recovery in subsequent steps.

At step 802, the UE 101 evaluates the execution condition of fallback secondary node 105.

In an embodiment, if the execution condition is successful, the UE 101 may discard the validity timer associated with the fallback secondary node 105 and apply the fallback secondary node configuration. The UE 101 may send RRC(Connection)ReconfigurationComplete* message to the master node 102 including RRCReconfigurationComplete* containing fallback secondary node RRCReconfigurationComplete**.

In an embodiment, if the execution condition has failed, the UE 101 may send an SCGFailurelnformationFB message including, without limitation to, a new IE “execCondFail” (set as TRUE). If the value of “execCondFail” is set as TRUE, the UE 101 and the master node 102 may release the fallback secondary node configuration and the master node 102 may then perform steps for a fresh secondary node configuration.

At step 803a, the master node 102 may indicate reconfigurationcomplete to the fallback secondary node 105 and release the secondary node 104.

At step 803b, the master node 102 may send a releaserequest message to the secondary node 104, to release the resources reserved for the UE 101.

At step 803c, the master node 102 may receive releaserequest-acknowledgement from the secondary node 104.

At step 804, synchronization between the UE 101 and the fallback secondary node 105, via RACH procedure may take place when the fallback secondary node's 105 execution condition is successful and the and the fallback secondary node configuration has been applied.

At step 805a, the secondary node 104 may send the last successful data packet Sequence Number (SN) report to the master node 102 for data recovery.

At step 805b, the master node 102 may send the SN report to the fallback secondary node 105 for data recovery.

At step 806, data forwarding path may be updated between the master node 102 and the core network elements towards fallback secondary node 105 as the new serving secondary node.

In an embodiment, when the master node 102 belongs to a 4G RAT (LTE), according to the updated data path, from step 807 onwards, E-UTRAN Radio Access Bearer (E-RAB) modification indication may be exchanged between the master node 102 and the core network elements (S-GW/UPF 8001 and MME/AMF 8002). For example, at step 807, the secondary node 104 may send secondary RAT data usage report to the master node 102. At step 808, the master node 102 mat send E-RAB/PDU session resource modification indication to the MME/AMF 8002.

At step 809, the MME/AMF 8002 may send to bearer modification to the S-GW/UPF 8001. At step 810, the S-GW/UPF 8001 may send end marker packet to the fallback secondary node 105 via the master node 102. At step 811, the S-GW/UPF 8001 may send a message for a new path to the fallback secondary node 105. At step 812, the MME/AMF 8002 may send E-RAB/PDU session resource modification confirm to the master node 102. At step 813, the master node may release UE context of the secondary node 104.

In an embodiment, when the master node 102 belongs to a 5G RAT (NR), according to the updated data path, from step 807 onwards, Packet Data Unit (PDU) session resource modification indication may be exchanged between the master node 102 and the core network elements (UPF and AMF).

At step 813, the master node 102 may send a message requesting the secondary node 104 to release the UE context.

In an embodiment, before step 802, the master node 102 may already reserve another alternate secondary node configuration via secondary node addition procedure while waiting the UE 101 evaluates the fallback secondary node's 105 execution condition. The master node 102 may release the alternate secondary node's configuration in the event that the fallback secondary node's 105 evaluation by the UE 101 is successful or may configure the alternate secondary node's configuration in the event that the fallback secondary node's 105 evaluation by the UE 101 is not successful.

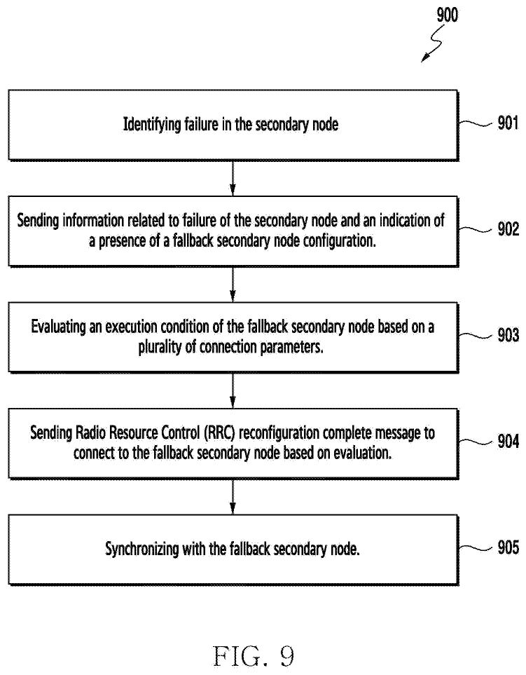

FIG. 9 is a flowchart illustrating an example method 900 for secondary node failure recovery in a non-standalone (NSA) communication system, according to various embodiments.

At 901, the method 900 may comprise identifying failure in the secondary node 104, by the UE 101 connected to the master node 102 and the secondary node 104.

In an embodiment, the secondary node 104 and the fallback secondary node 105 may belong to one of, a same or a different RAT as the master node 102. For example, the master node 102 may belong to 4G/5G RAT and the plurality of secondary nodes 103 may belong to a 5G/6G RAT or 6G RAT respectively.

At 902, the method 900 may comprise sending information related to failure of the secondary node 104 and an indication of a presence of the fallback secondary node configuration by the UE 101 to the master node 102. In an embodiment, the fallback secondary node configuration may be received from the master node 102.

In an embodiment, the UE 101 may initiate a validity timer associated with the fallback secondary node 105. While the validity timer is running and until the expiry of the validity timer, the UE 101 may measure and report one or more of a plurality of connection parameters associated with the fallback secondary node 105, to the master node 102. The plurality of connection parameters may comprise, without limitation to, signal strength measurement parameters associated with the fallback secondary node 105 and a signal quality associated with the fallback secondary node 105. For example, if the signal strength of the fallback secondary node 105, is within its threshold range, the UE 101 may measure and report this to the master node 102 and the master node 102 may decide to keep the validity timer running be renewing/restarting the validity timer. If the signal strength of the fallback secondary node 105, is outside its threshold range, the UE 101 may measure and report this to the master node 102 and the master node 102 may not send a message to the UE 101 to keep the validity timer running and the validity timer may eventually run out.

In an embodiment, the UE 101 may send to the master node 102, information indicating the expiry of the validity timer and may release the fallback secondary node configuration when the validity timer has expired.

At 903, the method 900 may comprise evaluating an execution condition of the fallback secondary node 105 based on a plurality of connection parameters by the UE 101.

In an embodiment, evaluating execution condition of the fallback secondary node 105 comprises determining that each of a plurality of connection parameters associated with the fallback secondary node 105 are within their respective threshold ranges, e.g., if all the connection parameters associated with fallback secondary node 105 are within their respective threshold ranges, the fallback secondary node 105 may be evaluated as successful. If one of the plurality of connection parameters associate with the fallback secondary node 105 is outside their respective threshold range, then the fallback secondary node 105 may be evaluated as failure.

At 904, the method 900 comprises sending RRC reconfiguration complete message to connect to the fallback secondary node 105 based on evaluation by the UE 101 to the master node 102.

At 905, the method 900 comprises synchronizing the UE 101 with the fallback secondary node 105.

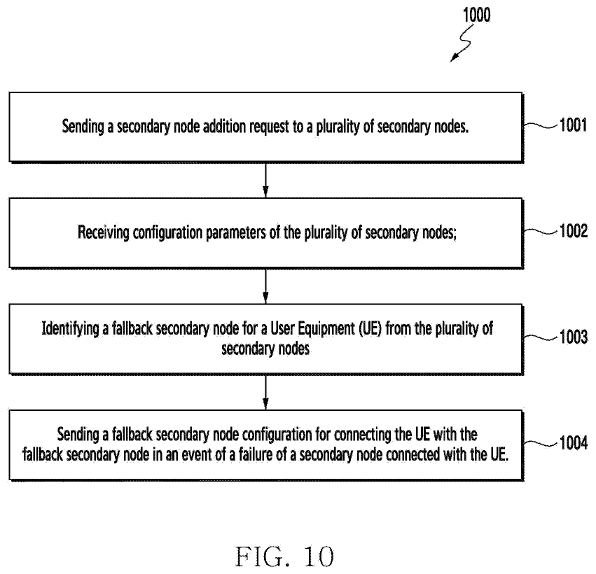

FIG. 10 is a flowchart illustrating an example method 1000 for secondary node failure recovery in a non-standalone (NSA) communication system, according to various embodiments.

At 1001, the method 1000 may comprise sending a secondary node addition request to a plurality of secondary nodes 103 by the master node 102.

In an embodiment, the plurality of secondary nodes 103 may comprise, without limitation to, the secondary node 104, the fallback secondary node 105.

In an embodiment, the plurality of secondary nodes, the secondary node 104 and the fallback secondary node 105 may belong to one of, a same or a different RAT as the master node 102. For example, the master node 102 may belong to 4G/5G RAT and the plurality of secondary nodes 103 may belong to a 5G/6G RAT or 6G RAT respectively.

At 1002, the method 1000 may comprise receiving configuration parameters of the plurality of secondary nodes 103 by the master node 102.

At 1003, the method 1000 may comprise identifying the fallback secondary node 105 for the UE 101 from the plurality of secondary nodes 103 by the master node 102. In an embodiment, the master node 102 may send a request to reserve resources for the UE 101, to the fallback secondary node 105. The master node 102 may receive a confirmation indicating reservation of resources for the UE 101 from the fallback secondary node 105.

At 1004, the method 1000 may comprise sending the fallback secondary node configuration for connecting the UE 101 with the fallback secondary node 105 in an event of a failure of the secondary node 104 connected with the UE 101, by the master node 102 to the UE 101. Further to the master node 102 sending the fallback secondary node configuration to the UE 101, it may receive a report of one or more of the plurality of connection parameters associated with the fallback secondary node 105 from the UE 101.

In an embodiment, the plurality of connection parameters may comprise, without limitation to, signal strength measurement parameters associated with the fallback secondary node 105 and signal quality associated with the fallback secondary node 105.

When, one or more of the one or more of the plurality of connection parameters are within their respective threshold ranges the master node 102 may send a message to restart the validity timer to the UE 101. For example, if the signal strength of the fallback secondary node 105, is within its threshold range, the UE 101 may receive a report indicating the same from the UE 101.

In such a case, the master node 102 may decide to keep the validity timer running be renewing/restarting the validity timer. If the signal strength of the fallback secondary node 105, is outside its threshold range, and the master node 102 may not send a message to the UE 101 to keep the validity timer running and the validity timer may eventually run out.

In an embodiment, when the master node 102 receives information indicating expiration of the validity timer from the UE 101, the master node 102 may send a request to the fallback secondary node 105 to release resources reserved for the UE 101.

In an embodiment the method 1000 may further comprise receiving from the UE 101 information related to failure of the secondary node 104 and an indication of the presence of a valid fallback secondary node configuration, by the master node 102.

In an embodiment the method 1000 may further comprise receiving by the master node 102 from the UE 101 receiving an RRC reconfiguration complete message to connect the UE 101 to the fallback secondary node 105, based on evaluation of the fallback secondary node by the UE 101 and sending an acknowledgement to the fallback secondary node 105 by the master node 102, acknowledging the receipt of the RRC reconfiguration complete message. The master node 102 may the release the failed the secondary node 104.

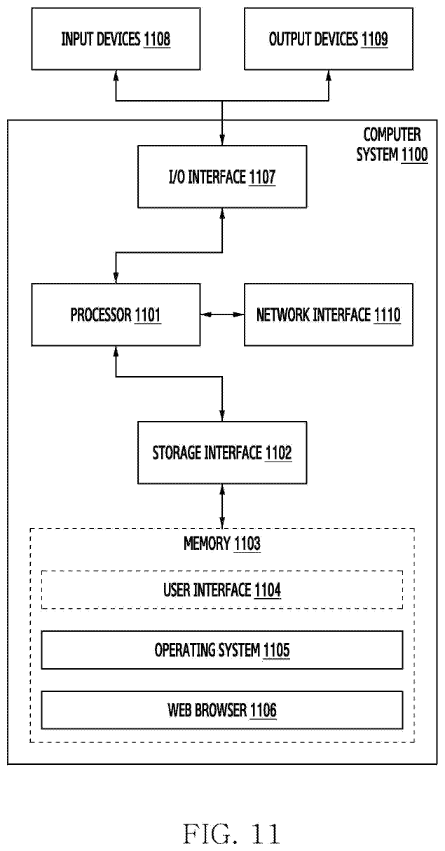

FIG. 11 is a block diagram illustrating an example configuration of an example computer system 1100, according to various embodiments. The computer system 1100 may be, without limitation to, the UE 101 or master node 102 or any of the plurality of secondary nodes 103. The computer system 1100 may include a central processing unit (“CPU” or “processor” e.g., including processing circuitry) 1101. The processor 1101 may include at least one data processor for executing processes. The processor 1101 may include specialized processing units such as, integrated system (bus) controllers, memory management control units, floating point units, graphics processing units, digital signal processing units, etc. The processor 1101 according to an embodiment of the disclosure may include various processing circuitry and/or multiple processors.

For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 1101 may be disposed in communication with one or more input/output (I/O) devices (e.g., including various circuitry)_1108 and 1109 via I/O interface (e.g., including I/O circuitry) 1107. The I/O interface 1107 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1107, the computer system 1100 may communicate with one or more I/O devices 1108 and 1109. For example, the input devices 1108 may include an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 1109 may include a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In various embodiments, the processor 1101 may be disposed in communication with external elements such as external computer systems, servers, network elements. The network interface 1110 may employ connection protocols including, without limitation, direct connect, Ethernet (e.g., twisted pair 10/100/1000 Base T), transmission control protocol/internet protocol (TCP/IP), token ring, IEEE 802.11 a/b/g/n/x, etc.

In various embodiments, the processor 1101 may be disposed in communication with a memory 1103 (e.g., RAM, ROM, etc.) via a storage interface 1102. The storage interface 1102 may connect to memory 1103 including, without limitation, memory drives, removable disc drives, etc., employing connection protocols such as, serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 1103 may store a collection of program or database components, including, without limitation, user interface 1104, an operating system 1105, a web browser 1106, or the like, each of which may include various processing circuitry and/or executable program instructions. In various embodiments, computer system 1100 may store user/application data, such as, the data, variables, records, etc., as described in this disclosure. Such databases may be implemented as fault-tolerant, relational, scalable, secure databases such as Oracle® or Sybase®.

The operating system 1105 may facilitate resource management and operation of the computer system 1100. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™ VISTA™/7/8, 10 etc.), APPLE® IOS™ GOOGLE® ANDROID™, BLACKBERRY® OS, or the like.

In various embodiments, the computer system 1100 may implement the web browser 1106 stored program components. The web browser 1106 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 1106 may utilize facilities such as AJAX, DHTML, ADOBE® FLASH®, JAVASCRIPT®, JAVA®, Application Programming Interfaces (APIs), etc. In various embodiments, the computer system 1100 may implement a mail server stored program component. The mail server may be an Internet mail server such as Microsoft Exchange, or the like. The mail server may utilize facilities such as Active Server Pages (ASP), ACTIVEX®, ANSI® C++/C #, MICROSOFT®, NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In various embodiments, the computer system 1100 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD©, etc.

According to embodiments, a method for secondary node failure recovery in a non-standalone (NSA) communication system may comprise identifying, by a User Equipment (UE) connected to a master node and a secondary node, failure in the secondary node. The method may comprise sending, by the UE to the master node, information related to failure of the secondary node and an indication of a presence of a fallback secondary node configuration. The method may comprise evaluating, by the UE, an execution condition of the fallback secondary node based on a plurality of connection parameters. The method may comprise sending, by the UE to the master node, a Radio Resource Control (RRC) reconfiguration complete message to connect to the fallback secondary node based on the evaluation. The method may comprise synchronizing, by the UE, with the fallback secondary node.

In an embodiment, the secondary node and the fallback secondary node may be one of, a same or a different Radio Access Technology (RAT).

In an embodiment, the fallback secondary node configuration is received from the master node.

In an embodiment, the method may comprise initiating, by the UE, a validity timer associated with the fallback secondary node. The method may comprise measuring and reporting, by the UE, one or more of a plurality of connection parameters associated with the fallback secondary node, to the master node until an expiry of the validity timer. The method may comprise sending, by the UE to the master node, information indicating the expiry of the validity timer. The method may comprise releasing, by the UE, the fallback secondary node configuration based on the validity timer expiring.

In an embodiment, the method may comprise restarting the validity timer based on measuring of the one or more of the plurality of connection parameters.

In an embodiment, the evaluating execution condition of the fallback secondary node may comprise determining whether each of a plurality of connection parameters associated with the fallback secondary node are within respective threshold ranges.

In an embodiment, the plurality of connection parameters may comprise signal strength measurement parameters associated with the fallback secondary node and a signal quality associated with the fallback secondary node.

According to embodiments, a method for secondary node failure recovery in a non-standalone (NSA) communication system may comprise sending, by a master node, a secondary node addition request to a plurality of secondary nodes. The method may comprise receiving, by the master node, configuration parameters of the plurality of secondary nodes. The method may comprise identifying, by the master node, a fallback secondary node for a User Equipment (UE) from the plurality of secondary nodes. The method may comprise sending, by the master node to the UE, a fallback secondary node configuration for connecting the UE with the fallback secondary node based on a failure of a secondary node connected with the UE.

In an embodiment, the identifying the fallback secondary node may comprise sending, by the master node to the fallback secondary node, a request to reserve resources for the UE. The identifying the fallback secondary node may comprise receiving, by the master node from the from the fallback secondary node, a confirmation indicating reservation of resources for the UE.

In an embodiment, the method may comprise receiving, by the master node from the UE, information related to failure of the secondary node and an indication of the presence of a valid fallback secondary node configuration. The method may comprise receiving, by the master node from the UE, a radio resource control (RRC) reconfiguration complete message to connect the UE to the fallback secondary node, based on evaluation of the fallback secondary node by the UE. The method may comprise sending, by the master node, an acknowledgement to the fallback secondary node. The method may comprise releasing, by the master node, the secondary node.

In an embodiment, the sending the fallback secondary node configuration may comprise receiving, by the master node from the UE, a report of one or more of a plurality of connection parameters associated with the fallback secondary node. The sending the fallback secondary node configuration may comprise sending, by the master node to the UE, a message to restart the validity timer when one or more of the plurality of connection parameters are within their respective threshold ranges.

In an embodiment, the method may comprise receiving, by the master node from the UE, information indicating expiration of the validity timer. The method may comprise sending, by the master node to the fallback secondary node, a request to release resources reserved for the UE.

In an embodiment, the secondary node and the fallback secondary node include one of, a same or a different Radio Access Technology (RAT).

In an embodiment, the plurality of connection parameters comprises: signal strength measurement parameters associated with the fallback secondary node and a signal quality associated with the fallback secondary node.

According to embodiments, a User Equipment (UE) for secondary node failure recovery in a non-standalone (NSA) communication system may comprise a memory. The UE may comprise at least one processor, comprising processing circuitry, connected to a master node and a secondary node. The at least one processor, individually and/or collectively, may be configured to identify failure in the secondary node. The at least one processor, individually and/or collectively, may be configured to send, to the master node, information related to failure of the secondary node and an indication of a presence of a fallback secondary node configuration. The at least one processor, individually and/or collectively, may be configured to evaluate an execution condition of the fallback secondary node based on a plurality of connection parameters. The at least one processor, individually and/or collectively, may be configured to send, to the master node, a Radio Resource Control (RRC) reconfiguration complete message to connect to the fallback secondary node based on the evaluation. The at least one processor, individually and/or collectively, may be configured to synchronize with the fallback secondary node.

In an embodiment, the secondary node and the fallback secondary node may include one of, a same or a different Radio Access Technology (RAT).

In an embodiment, the fallback secondary node configuration is received from the master node.

In an embodiment, the at least one processor, individually and/or collectively, may be configured to initiate a validity timer associated with the fallback secondary node. The at least one processor, individually and/or collectively, may be configured to measure and report, one or more of a plurality of connection parameters associated with the fallback secondary node, to the master node until an expiry of the validity timer. The at least one processor, individually and/or collectively, may be configured to send, to the master node, information indicating the expiry of the validity timer. The at least one processor, individually and/or collectively, may be configured to release the fallback secondary node configuration based on the validity timer expiring.

In an embodiment, the at least one processor, individually and/or collectively, may be configured to restart the validity timer based on measuring of the one or more of the plurality of connection parameters.

In an embodiment, the at least one processor, individually and/or collectively, may be configured to evaluate the execution condition of the fallback secondary node is configured to determine whether each of a plurality of connection parameters associated with the fallback secondary node are within their respective threshold ranges.

According to embodiments, a master node for secondary node failure recovery in a non-standalone (NSA) communication system may comprise a memory. The master node may comprise at least one processor, comprising processing circuitry. The at last one processor, individually and/or collectively, may be configured to send a secondary node addition request to a plurality of secondary nodes. The at last one processor, individually and/or collectively, may be configured to receive configuration parameters of the plurality of secondary nodes. The at last one processor, individually and/or collectively, may be configured to identify a fallback secondary node for a User Equipment (UE) from the plurality of secondary nodes. The at last one processor, individually and/or collectively, may be configured to send a fallback secondary node configuration for connecting the UE with the fallback secondary node in an event of a failure of a secondary node connected with the UE.

In an embodiment, the at least one processor, individually and/or collectively, may be configured to identify the fallback secondary node by sending, to the fallback secondary node, a request to reserve resources for the UE. The at least one processor, individually and/or collectively, may be configured to identify the fallback secondary node by receiving from the fallback secondary node, a confirmation indicating reservation of resources for the UE.

In an embodiment, the at least one processor, individually and/or collectively, may be configured to receive from the UE, information related to failure of the secondary node and an indication of the presence of a valid fallback secondary node configuration. The at least one processor, individually and/or collectively, may be configured to receive from the UE, a radio resource control (RRC) reconfiguration complete message to connect the UE to the fallback secondary node, based on evaluation of the fallback secondary node by the UE. The at least one processor, individually and/or collectively, may be configured to send an acknowledgement to the fallback secondary node. The at least one processor, individually and/or collectively, may be configured to release the secondary node.

In an embodiment, the at least one processor, individually and/or collectively, may be configured to send the fallback secondary node configuration by receiving from the UE, a report of one or more of a plurality of connection parameters associated with the fallback secondary node.

The at least one processor, individually and/or collectively, may be configured to send the fallback secondary node configuration by sending to the UE, a message to restart the validity timer based on one or more of the plurality of connection parameters being within respective threshold ranges.

In an embodiment, the at least one processor, individually and/or collectively, may be configured to receive from the UE, information indicating expiration of the validity timer. The at least one processor, individually and/or collectively, may be configured to send to the fallback secondary node, a request to release resources reserved for the UE.

In an embodiment, the secondary node and the fallback secondary node include one of, a same or a different Radio Access Technology (RAT).

According to embodiments, a method performed by a user equipment (UE) for secondary node failure recovery in a non-standalone (NSA) communication system may comprise identifying failure in a secondary node, the UE being connected to a master node and the secondary node. The method may comprise sending, to the master node, information related to the failure of the secondary node and an indication of a presence of a fallback secondary node configuration.

The method may comprise evaluating an execution condition of the fallback secondary node based on a plurality of connection parameters. The method may comprise sending, to the master node, a Radio Resource Control (RRC) reconfiguration complete message to connect to the fallback secondary node based on that the execution condition is succeeded.

In an embodiment, the secondary node and the fallback secondary node may be one of, a same or a different Radio Access Technology (RAT).

In an embodiment, the method may comprise synchronizing, by the UE, with the fallback secondary node The fallback secondary node configuration may be received from the master node.

In an embodiment, the method may comprise initiating a validity timer associated with the fallback secondary node. The method may comprise measuring and reporting one or more of a plurality of connection parameters associated with the fallback secondary node, to the master node until an expiry of the validity timer. The method may comprise sending, to the master node, information indicating the expiry of the validity timer. The method may comprise releasing the fallback secondary node configuration based on the validity timer expiring.

In an embodiment, the method may comprise restarting the validity timer based on measuring of the one or more of the plurality of connection parameters.

In an embodiment, the evaluating execution condition of the fallback secondary node may comprise determining whether each of a plurality of connection parameters associated with the fallback secondary node is within threshold ranges.

In an embodiment, the plurality of connection parameters may comprise signal strength measurement parameters associated with the fallback secondary node and a signal quality associated with the fallback secondary node.

According to embodiments, a method performed by a master node for secondary node failure recovery in a non-standalone (NSA) communication system may comprise sending a secondary node addition request to a plurality of secondary nodes. The method may comprise receiving configuration parameters of the plurality of secondary nodes. The method may comprise identifying a fallback secondary node for a User Equipment (UE) from the plurality of secondary nodes. The method may comprise sending, to the UE, a fallback secondary node configuration for connecting the UE with the fallback secondary node based on a failure of a secondary node connected with the UE.

In an embodiment, the identifying the fallback secondary node may comprise sending, by the master node to the fallback secondary node, a request to reserve resources for the UE. The identifying the fallback secondary node may comprise receiving, by the master node from the from the fallback secondary node, a confirmation indicating reservation of resources for the UE.

In an embodiment, the method may comprise receiving, from the UE, information related to failure of the secondary node and an indication of the presence of a valid fallback secondary node configuration. The method may comprise receiving, from the UE, a radio resource control (RRC) reconfiguration complete message to connect the UE to the fallback secondary node, based on evaluation of the fallback secondary node by the UE. The method may comprise sending an acknowledgement to the fallback secondary node. The method may comprise releasing the secondary node.

In an embodiment, the sending the fallback secondary node configuration may comprise receiving, from the UE, a report of one or more of a plurality of connection parameters associated with the fallback secondary node. The sending the fallback secondary node configuration may comprise sending, to the UE, a message to restart the validity timer when one or more of the plurality of connection parameters are within their respective threshold ranges.

In an embodiment, the method may comprise receiving, from the UE, information indicating expiration of the validity timer. The method may comprise sending, to the fallback secondary node, a request to release resources reserved for the UE.

In an embodiment, the secondary node and the fallback secondary node include one of, a same or a different Radio Access Technology (RAT).

In an embodiment, the plurality of connection parameters comprises: signal strength measurement parameters associated with the fallback secondary node and a signal quality associated with the fallback secondary node.

According to embodiments, a User Equipment (UE) for secondary node failure recovery in a non-standalone (NSA) communication system may comprise a memory. The UE may comprise at least one processor, comprising processing circuitry, connected to a master node and a secondary node. The at least one processor, individually and/or collectively, may be configured to identify failure in a secondary node. The UE may be connected to a master node and the secondary node. The at least one processor, individually and/or collectively, may be configured to send, to the master node, information related to the failure of the secondary node and an indication of a presence of a fallback secondary node configuration. The at least one processor, individually and/or collectively, may be configured to evaluate an execution condition of the fallback secondary node based on a plurality of connection parameters. The at least one processor, individually and/or collectively, may be configured to send, to the master node, a Radio Resource Control (RRC) reconfiguration complete message to connect to the fallback secondary node based on that the evaluation condition is succeeded.

In an embodiment, the secondary node and the fallback secondary node may include one of, a same or a different Radio Access Technology (RAT).

In an embodiment, the at least one processor, individually and/or collectively, may be configured to synchronize with the fallback secondary node. The fallback secondary node configuration be received from the master node.

In an embodiment, the at least one processor, individually and/or collectively, may be configured to initiate a validity timer associated with the fallback secondary node. The at least one processor, individually and/or collectively, may be configured to measure and report, one or more of a plurality of connection parameters associated with the fallback secondary node, to the master node until an expiry of the validity timer. The at least one processor, individually and/or collectively, may be configured to send, to the master node, information indicating the expiry of the validity timer. The at least one processor, individually and/or collectively, may be configured to release the fallback secondary node configuration based on the validity timer expiring.

In an embodiment, the at least one processor, individually and/or collectively, may be configured to restart the validity timer based on measuring of the one or more of the plurality of connection parameters.

In an embodiment, the at least one processor, individually and/or collectively, may be configured to evaluate the execution condition of the fallback secondary node is configured to determine whether each of a plurality of connection parameters associated with the fallback secondary node is within respective threshold ranges.

Furthermore, one or more computer-readable storage media may be utilized in implementing various embodiments of the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with various embodiments described herein. The term “computer-readable medium” should be understood to include tangible items and exclude carrier waves and transient signals, e.g., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the disclosure, and that the article of manufacture may include suitable information bearing medium known in the art.

The terms “a”, “an” and “the” refer, for example, to “one or more”, unless expressly specified otherwise.

A description of an example embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, various embodiments of the disclosure need not include the device itself.

The illustrated operations of FIGS. 1-10 may illustrate various events occurring in a certain order. In various embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The language used in the disclosure has been principally selected for readability and instructional purposes, and it may not have been selected to delineate or circumscribe the disclosed subject matter. It is therefore intended that the scope of the disclosure not be limited not by this detailed description. Accordingly, the embodiments of the disclosure are intended to be illustrative, but not limiting, of the scope of the disclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit including the following claims. It will also be understood that any of the embodiment(s) described herein may be used in conjunction with any other embodiment(s) described herein.

What is claimed is:

1. A method performed by a user equipment (UE) for secondary node failure recovery in a non-standalone (NSA) communication system comprising:
identifying failure in a secondary node, the UE being connected to a master node and the secondary node;
sending, to the master node, information related to the failure of the secondary node and an indication of a presence of a fallback secondary node configuration;
evaluating an execution condition of the fallback secondary node based on a plurality of connection parameters; and
sending, to the master node, a Radio Resource Control (RRC) reconfiguration complete message to connect to the fallback secondary node based on that the execution condition is succeeded.

2. The method of claim 1, wherein the secondary node and the fallback secondary node are one of, a same or a different Radio Access Technology (RAT).

3. The method of claim 1, further comprising:
synchronizing, by the UE, with the fallback secondary node,
wherein the fallback secondary node configuration is received from the master node.

4. The method of claim 3, further comprising:
initiating a validity timer associated with the fallback secondary node;
measuring and reporting one or more of a plurality of connection parameters associated with the fallback secondary node, to the master node until an expiry of the validity timer;
sending, to the master node, information indicating the expiry of the validity timer; and
releasing the fallback secondary node configuration based on the validity timer expiring.

5. The method of claim 4, further comprising:
restarting the validity timer based on measuring of the one or more of the plurality of connection parameters.

6. The method of claim 1, wherein evaluating execution condition of the fallback secondary node comprises: determining whether each of a plurality of connection parameters associated with the fallback secondary node is within threshold ranges.

7. The method of claim 5, wherein the plurality of connection parameters comprise signal strength measurement parameters associated with the fallback secondary node and a signal quality associated with the fallback secondary node.

8. A method performed by a master node for secondary node failure recovery in a non-standalone (NSA) communication system comprising:
sending a secondary node addition request to a plurality of secondary nodes;
receiving configuration parameters of the plurality of secondary nodes;
identifying a fallback secondary node for a User Equipment (UE) from the plurality of secondary nodes; and
sending, to the UE, a fallback secondary node configuration for connecting the UE with the fallback secondary node based on a failure of a secondary node connected with the UE.

9. The method of claim 8, wherein identifying the fallback secondary node further comprises:
sending, to the fallback secondary node, a request to reserve resources for the UE; and
receiving, from the fallback secondary node, a confirmation indicating reservation of resources for the UE.

10. The method of claim 9, further comprising:
receiving, from the UE, information related to failure of the secondary node and an indication of the presence of a valid fallback secondary node configuration;
receiving, from the UE, a radio resource control (RRC) reconfiguration complete message to connect the UE to the fallback secondary node, based on evaluation of the fallback secondary node by the UE;
sending an acknowledgement to the fallback secondary node; and
releasing the secondary node.

11. The method of claim 9, wherein sending the fallback secondary node configuration further comprises:
receiving, from the UE, a report of one or more of a plurality of connection parameters associated with the fallback secondary node; and
sending, to the UE, a message to restart the validity timer when one or more of the plurality of connection parameters are within their respective threshold ranges.

12. The method of claim 11, further comprises:
receiving, from the UE, information indicating expiration of the validity timer; and
sending, to the fallback secondary node, a request to release resources reserved for the UE.

13. The method of claim 8, wherein the secondary node and the fallback secondary node include one of, a same or a different Radio Access Technology (RAT).

14. The method of claim 11, wherein the plurality of connection parameters comprise: signal strength measurement parameters associated with the fallback secondary node and a signal quality associated with the fallback secondary node.

15. A User Equipment (UE) for secondary node failure recovery in a non-standalone (NSA) communication system comprising:
a memory; and
at least one processor comprising processing circuitry,
wherein the at least one processor, individually and/or collectively, is configured to:
identify failure in a secondary node, the UE being connected to a master node and the secondary node;
send, to the master node, information related to the failure of the secondary node and an indication of a presence of a fallback secondary node configuration;
evaluate an execution condition of the fallback secondary node based on a plurality of connection parameters; and
send, to the master node, a Radio Resource Control (RRC) reconfiguration complete message to connect to the fallback secondary node based on that the evaluation condition is succeeded.

16. The UE of claim 15, wherein the secondary node and the fallback secondary node include one of, a same or a different Radio Access Technology (RAT).

17. The UE of claim 15, wherein the at least one processor, individually and/or collectively, is configured to:
synchronize with the fallback secondary node,
wherein the fallback secondary node configuration is received from the master node.

18. The UE of claim 17, wherein the at least one processor, individually and/or collectively, is configured to:
initiate a validity timer associated with the fallback secondary node;
measure and report, one or more of a plurality of connection parameters associated with the fallback secondary node, to the master node until an expiry of the validity timer;
send, to the master node, information indicating the expiry of the validity timer; and
release the fallback secondary node configuration based on the validity timer expiring.

19. The UE of claim 18, wherein the at least one processor, individually and/or collectively, is configured to:
restart the validity timer based on measuring of the one or more of the plurality of connection parameters.

20. The UE of claim 15, wherein the at least one processor, individually and/or collectively, is configured to evaluate the execution condition of the fallback secondary node is configured to: determine whether each of a plurality of connection parameters associated with the fallback secondary node is within threshold ranges.
